(19) United States
(12) Patent Application Publication
(10) Pub. No.: US 2026/0289265 A1
(43) Pub. Date: Sep. 24, 2026

(54) SYSTEM

(71) Applicant: SoftBank Group Corp., Tokyo (JP)

(72) Inventor: Fuminari YUKI, Tokyo (JP)

(73) Assignee: SoftBank Group Corp., Tokyo (JP)

(21) Appl. No.: 19/565,565

(22) Filed: Mar. 13, 2026

(30) Foreign Application Priority Data
Mar. 19, 2025 (JP) 2025-045149

(51) Int. Cl. G06N 3/0475; G06Q 30/0601; H04L 51/216

(52) U.S. Cl. CPC G06N 3/0475; G06Q 30/0621; H04L 51/216

(57) ABSTRACT

A system includes a processor that is configured to cause a terminal to provide a group chat of a messenger application in which a user inputs leftover food information and shares the leftover food information with participating members, receive preference information and dietary restriction information of the participating members and store the preference information and the dietary restriction information in a database, generate a prompt for instructing a generative artificial intelligence model to propose a menu and cooking procedures based on the leftover food information and the preference information and dietary restriction information, evaluate an emotion of the user by using an emotion analysis engine and optimize the proposed menu and cooking procedures based on a result of the evaluation, and identify one or more missing ingredients, place an order via an online ordering system, and cause the missing ingredients to be provided to the user through a delivery service.

### CROSS-REFERENCE TO RELATED APPLICATION

This application is based on and claims priority under 35 USC 119 from Japanese Patent Application No. 2025-045149 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional meal planning and grocery management systems require users to manually search for recipes, determine how to use leftover ingredients in a refrigerator, and then separately purchase missing ingredients. In such systems, user preferences, dietary restrictions, and emotional states are not sufficiently taken into account, resulting in proposed menus that are not well tailored to individual or group needs. Furthermore, communication among family members or group members regarding daily meals tends to be fragmented across different applications and lacks an integrated mechanism that continuously engages users. As a result, there is no seamless workflow that combines (i) group-based sharing of leftover food information, (ii) personalized and dynamically optimized menu and recipe generation using a generative artificial intelligence model and emotion analysis, and (iii) automatic ordering and delivery of missing ingredients. Additionally, there is no integrated framework that utilizes these daily meal-related touchpoints to collect feedback for evolving recommendations and to promote upselling of related products or services such as travel packages. Therefore, there is a need for a system that centrally manages refrigerator leftovers, member preferences, emotional analysis, and online ordering, while also enhancing family or group engagement and enabling continuous improvement and monetization opportunities.

### SUMMARY

To solve the above-described problems, the present invention provides a system comprising a processor configured to operate in conjunction with a messenger application, a generative artificial intelligence model, an emotion analysis engine, and an online ordering system. The processor is configured to cause a terminal to provide a group chat of the messenger application in which a user inputs leftover food information representing contents of a refrigerator and shares the leftover food information with other participating members, and to receive, from the user, preference information and dietary restriction information of the participating members and store the preference information and the dietary restriction information in a database. The processor is further configured to generate a prompt for instructing the generative artificial intelligence model to propose a menu and cooking procedures based on the stored leftover food information and the stored preference information and dietary restriction information, and to evaluate an emotion of the user by using the emotion analysis engine and optimize the proposed menu and cooking procedures based on a result of the evaluation. In addition, the processor is configured to identify, based on the proposed menu, one or more missing ingredients that are not included in the leftover food information, automatically place an order for the one or more missing ingredients via the online ordering system, and cause the missing ingredients to be provided to the user through a delivery service. The processor may further be configured to collect feedback from the participating members regarding the proposed menu and cooking procedures and input the feedback into the generative artificial intelligence model in order to evolve and improve subsequent proposals, and to promote communication among the participating members through the proposed menu and cooking procedures so as to secure daily in-home touchpoints and, as a result, attempt to perform upselling to travel-related or other products and services.

The term “processor” refers to one or more hardware-based processing units, such as a central processing unit (CPU), a graphics processing unit (GPU), a microcontroller, or a combination thereof, that executes instructions to perform the functions described in the present invention.

The term “terminal” refers to any user-operated electronic device capable of running a messenger application and communicating with the processor over a network, including but not limited to a smartphone, a tablet, a notebook computer, a desktop computer, or a smart home device.

The term “messenger application” refers to a software application or service that provides real-time or asynchronous messaging functions among multiple users, and that supports a group chat feature in which messages and content can be shared among participating members.

The term “group chat” refers to a communication space within the messenger application that includes a plurality of participating members and that allows the participating members to exchange text messages, images, and other information in a shared conversation thread.

The term “user” refers to an individual who operates the terminal, participates in the group chat of the messenger application, and interacts with the system by inputting information such as leftover food information, preferences, dietary restrictions, and feedback.

The term “participating member” refers to any user who is registered in and has access to a specific group chat in the messenger application, and who can view and share information such as leftover food information, proposed menus, and feedback within that group chat.

The term “leftover food information” refers to information representing foods or ingredients currently stored in a refrigerator or other storage place, including, for example, names of ingredients, quantities, expiration dates, and storage conditions, which are input by the user and managed by the system.

The term “preference information” refers to information indicating likes, dislikes, taste preferences, or other culinary tendencies of the participating members, including but not limited to preferred ingredients, disliked ingredients, preferred flavor profiles, and cuisine types.

The term “dietary restriction information” refers to information indicating dietary limitations or requirements of the participating members, including but not limited to allergies, medical restrictions, religious restrictions, vegan diets, vegetarian diets, low-carbohydrate diets, and low-sodium diets.

The term “database” refers to any structured or semi-structured data storage system, such as a relational database, a key-value store, or a document-oriented database, in which the system stores and manages leftover food information, preference information, dietary restriction information, feedback, and related data.

The term “generative artificial intelligence model” refers to a machine learning model, such as a neural network-based generative model or a large language model, that is capable of generating new content, including proposed menus and cooking procedures, based on input data and prompts.

The term “prompt” refers to a structured or unstructured set of instructions, input data, and contextual information that is provided to the generative artificial intelligence model to cause the generative artificial intelligence model to generate a menu and cooking procedures tailored to the leftover food information and the participating members' preferences and dietary restrictions.

The term “menu” refers to one or more proposed meal plans or dishes generated by the system based on leftover food information, preference information, and dietary restriction information, including a name or description of each dish and optionally associated meta-information such as servings or nutritional aspects.

The term “cooking procedures” refers to a sequence of instructions or steps for preparing and cooking one or more dishes included in the menu, including operations such as cutting, mixing, heating, seasoning, cooking times, and serving suggestions.

The term “emotion analysis engine” refers to a software or hardware component configured to analyze data related to the user, including but not limited to text messages, voice information, or interaction patterns, in order to estimate or evaluate the user's emotional state, such as happiness, stress, satisfaction, or dissatisfaction.

The term “emotion of the user” refers to an estimated emotional state or sentiment of the user, such as positive, negative, neutral, happy, sad, frustrated, or satisfied, which is inferred by the emotion analysis engine from user-related data.

The term “optimize the proposed menu and cooking procedures” refers to modifying, adjusting, or re-generating at least a part of the menu or the cooking procedures, based on the evaluation result of the user's emotion, so as to better match the user's or the participating members' preferences, mood, or context.

The term “missing ingredients” refers to one or more ingredients that are required for preparing the proposed menu and cooking procedures but are not included, or are insufficiently included, in the stored leftover food information managed by the system.

The term “online ordering system” refers to an electronic commerce platform or interface that allows the system to place orders for goods, including ingredients, over a network, and that can process order information such as product identifiers, quantities, delivery addresses, and payment information.

The term “delivery service” refers to a logistics or transportation service that physically delivers ordered ingredients or goods from a vendor or warehouse to a designated location associated with the user.

The term “feedback” refers to information provided by the participating members regarding their evaluation of the proposed menu and cooking procedures, including but not limited to explicit ratings, textual comments, satisfaction indicators, or reaction data.

The term “evolve and improve proposal contents” refers to updating, retraining, fine-tuning, or otherwise adapting the generative artificial intelligence model or its control parameters using the collected feedback, so that subsequent menus and cooking procedures are better suited to the participating members' preferences, dietary restrictions, and historical reactions.

The term “daily in-home touchpoints” refers to repeated and routine interaction opportunities within a household or among participating members, created through daily or frequent engagement with the proposed menus, cooking procedures, and related communications in the group chat.

The term “upselling” refers to presenting or recommending additional products or services, which may have higher value or be complementary to the core meal-planning service, to the user or the participating members, based on their usage patterns, preferences, and engagement within the system.

The term “travel-related products or services” refers to goods or services associated with travel or leisure activities, including but not limited to travel packages, tours, hotel reservations, local experience bookings, and destination-specific culinary events.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

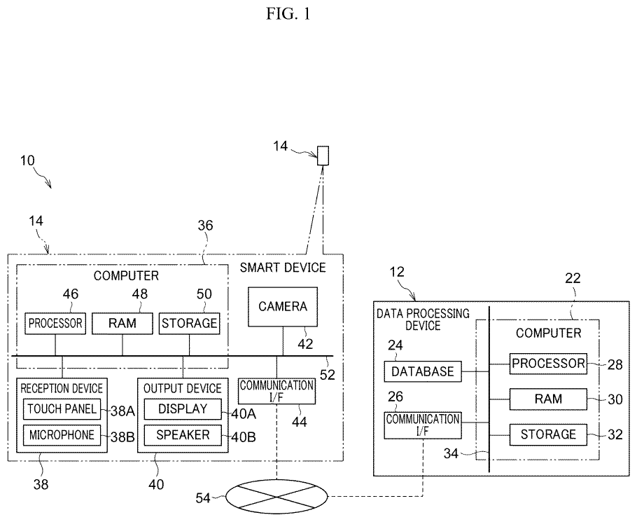

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein.

The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

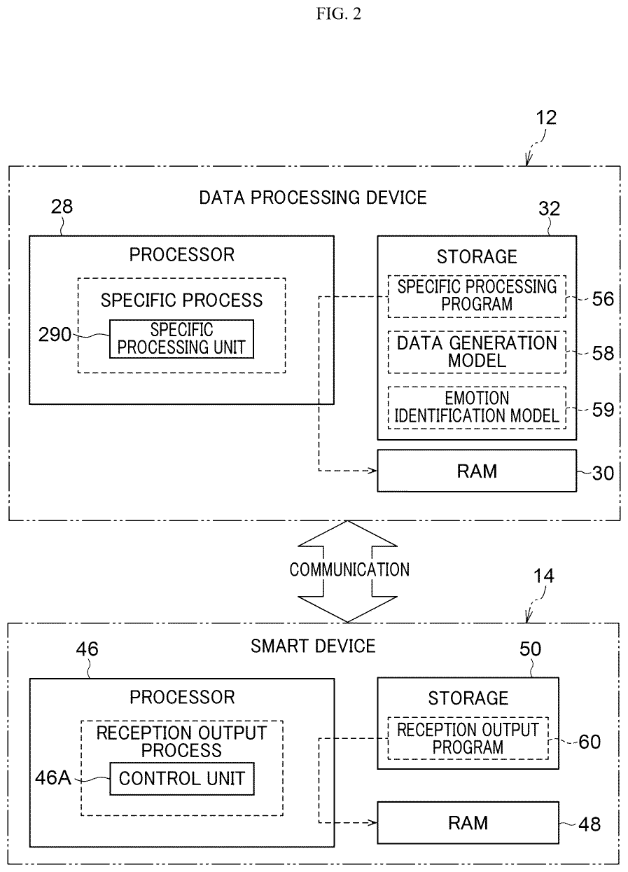

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented menu recommendation systems and household inventory management systems suffer from several technical limitations in how they acquire, structure, and utilize user-generated data and external AI services. First, when users enter free-form text in a group messaging environment to describe available food items or personal dietary preferences, existing systems typically treat such text merely as unstructured messages and either do not process it at all or perform only shallow keyword matching. As a result, the underlying information processing apparatus fails to reliably extract normalized item data or structured preference attributes, leading to inconsistent database states and reducing the effectiveness of subsequent automated processing.

Second, existing systems generally lack an integrated control mechanism by which a processor dynamically assembles and updates prompt sentences for a generative AI model based on current inventory records, structured preference information, and feedback from multiple participants. In many cases, human operators manually craft prompts to external AI services, and the computing system itself does not systematically manage prompt generation as part of its data processing pipeline. This leads to non-repeatable behavior, inefficient use of network and processing resources, and difficulties in maintaining a stable interface between the local database and the remote generative AI model.

Third, many known systems treat the output of AI-based recipe or menu generation as an isolated result, without technically integrating that result into subsequent machine-driven processes such as automatic comparison against structured inventory records, automated ordering of missing ingredients via an online transaction processing system, or continued refinement of AI prompts based on user feedback and updated inventory. Consequently, the processor does not fully exploit the structured state of the system, and must repeatedly perform redundant computations or manual operations, which degrades overall system performance and scalability.

Fourth, when multiple participants interact via group messaging, known systems do not effectively use the continuous stream of conversational data as a machine-readable resource for adaptive behavior. Dialogue logs, evaluation comments, and emotional or interest patterns are rarely incorporated into a persistent model of the group's preferences in a way that changes the behavior of the processor. In particular, prior systems do not provide a technical framework for analyzing dialogue-history information, extracting generalized interest areas, and using those areas to generate additional proposals for related services in a way that is closely integrated with the messaging interface and the underlying data storage structures.

Accordingly, there is a need for an improved computer-implemented system in which a processor (i) acquires user-generated text from a group messaging interface and converts it into normalized item identifiers and structured preference attributes stored in dedicated memory regions, (ii) programmatically constructs and reconfigures prompt sentences for a generative AI model based on current database contents and participant feedback, (iii) technically integrates the AI output into automated inventory comparison and online ordering workflows, and (iv) adaptively refines future AI interactions and related-service proposals based on structured analysis of dialogue history. Such a system would improve the way computers process, represent, and act upon user communications in a group messaging context, thereby enhancing reliability, efficiency, and extensibility of the overall information processing architecture.

The specific processing by the specific processing unit 290 of the data processing device 12 in Example 1 is realized by the following means.

The present invention provides a server comprising a processor and a memory, the processor being configured to execute instructions to acquire, via a message-processing application executed on a terminal, text information that a user inputs in a group communication screen regarding food stored in a storage apparatus, receive the text information via a communication control device, extract food item candidates from the text information, normalize the food item candidates into identifier information representing generalized item categories, and store the identifier information in an item-information storage region of the memory; to convert, by natural-language analysis processing, preference information and intake-restriction information of participants acquired via the message-processing application into structured attribute information, and store the attribute information in a preference-information storage region of the memory; to create a prompt sentence, based on food item information obtained from the item-information storage region and attribute information obtained from the preference-information storage region, for causing a generative AI model to generate a cooking-plan candidate and a cooking-procedure candidate, input the prompt sentence into the generative AI model, and obtain a generation result including the cooking-plan candidate and the cooking-procedure candidate from the generative AI model; to format the generation result into a text format adapted to an interface specification of the message-processing application, and transmit the formatted text to the group communication screen via the communication control device so that the generation result is shared among the participants; to compare food items required for the cooking-plan candidate and the cooking-procedure candidate with the food item information stored in the item-information storage region, identify missing components, transmit order information for the missing components to an online transaction processing system, and cause a distribution processing means to provide the missing components to the user; and to update the food information and the preference information stored in the respective storage regions in response to additional inputs from the user, reconfigure the prompt sentence supplied to the generative AI model in accordance with the updated contents, and repeatedly propose updated cooking-plan candidates and updated cooking-procedure candidates. This enables the computing system to transform unstructured group messaging content into normalized and persistently stored data, to algorithmically manage and adapt prompt sentences supplied to a generative AI model based on current inventory and participant state, to directly integrate AI-generated results into automated inventory comparison and ordering workflows, and to iteratively refine subsequent AI interactions and proposals, thereby improving the technical functioning, efficiency, and reliability of the underlying computer architecture for collaborative menu planning and inventory management.

The term “system” refers to a combination of hardware and software components that operate together to perform the functions described in the claims, including at least a processor, a memory, and a communication control device.

The term “processor” refers to one or more hardware processing units, such as a central processing unit or a microcontroller, configured to execute instructions to perform data acquisition, data analysis, prompt generation, communication control, and other functions described herein.

The term “memory” refers to one or more non-transitory storage media, such as semiconductor memory, magnetic storage, or optical storage, configured to store programs, configuration data, and various types of information including item information, preference information, and generated results.

The term “terminal” refers to an information processing device operated by a user, such as a smartphone, tablet, personal computer, or similar device, that executes a message-processing application and communicates with the server.

The term “message-processing application” refers to software executed on the terminal that provides a user interface for sending and receiving messages in a communication environment, including at least a group communication screen in which multiple participants can exchange text information.

The term “group communication screen” refers to a display region of the message-processing application in which text messages and related content exchanged among multiple participants in a group communication session are presented.

The term “communication control device” refers to a hardware and software combination, such as a network interface and associated control logic, configured to send and receive data between the server, the terminal, and external systems over a communication network.

The term “storage apparatus” refers to a physical storage facility for food items, such as a refrigerator, freezer, pantry, or similar environment in which food or ingredients are kept.

The term “text information” refers to character-based data representing user input, such as natural-language messages describing food items, preferences, or other content entered via the message-processing application.

The term “food item candidate” refers to a portion of the text information that is identified by the processor as possibly representing a food item or ingredient, prior to normalization into a structured identifier.

The term “identifier information” refers to a normalized representation of a food item, expressed as data that uniquely or generically identifies an item category, independent of surface text variations such as pluralization, spelling variations, or synonyms.

The term “generalized item category” refers to an abstracted classification of a food item, such as a canonical item name or item type, that groups together different textual expressions or subtypes of the same or similar ingredients.

The term “item-information storage region” refers to a logical area within the memory that is designated for storing normalized identifier information and associated metadata relating to food items available in the storage apparatus.

The term “preference information” refers to information describing a participant's likes, dislikes, dietary styles, or other positive or negative inclinations related to food selection.

The term “intake-restriction information” refers to information describing constraints on a participant's food consumption, such as allergies, medical restrictions, religious restrictions, or dietary restrictions including low-carbohydrate or gluten-free requirements.

The term “participant” refers to any user that is associated with the group communication screen and can send or receive messages, including a primary user and other members of a group.

The term “natural-language analysis processing” refers to a set of computational procedures applied to text information to derive structure, including but not limited to tokenization, part-of-speech tagging, entity recognition, classification, and transformation into structured attribute information.

The term “structured attribute information” refers to data in a predefined, machine-readable format, such as key-value pairs or database records, representing attributes of a participant's preferences or intake restrictions extracted from natural-language text.

The term “preference-information storage region” refers to a logical area within the memory that is designated for storing structured attribute information related to participants' preferences and intake restrictions.

The term “prompt sentence” refers to a natural-language or machine-readable instruction string generated by the processor and supplied as input to a generative AI model to control the content and style of the model's output.

The term “generative AI model” refers to a machine-learned model, such as a large language model or other generative model, configured to produce new text or structured content in response to an input prompt sentence.

The term “cooking-plan candidate” refers to one or more proposed menu items or meal configurations generated by the generative AI model based on available food item information and participant attribute information.

The term “cooking-procedure candidate” refers to one or more proposed step-by-step preparation procedures or instructions corresponding to a cooking-plan candidate, generated by the generative AI model.

The term “generation result” refers to the output data produced by the generative AI model in response to a prompt sentence, including at least a cooking-plan candidate and a cooking-procedure candidate.

The term “interface specification of the message-processing application” refers to the format and protocol requirements, including message structure and display capabilities, defined by the message-processing application for presenting text or other content in the group communication screen.

The term “formatted text” refers to a representation of the generation result that has been transformed by the processor to comply with the interface specification of the message-processing application so that it can be correctly displayed on the group communication screen.

The term “online transaction processing system” refers to a remote or local system that receives order information electronically, performs order handling and transaction processing in real time or near real time, and manages the purchase or reservation of goods or services.

The term “order information” refers to data specifying items to be procured, such as missing food components, together with quantities, delivery parameters, or customer identifiers, transmitted from the server to the online transaction processing system.

The term “distribution processing means” refers to one or more functional components, which may include external logistics services, configured to receive order fulfillment instructions and physically deliver ordered items or services to the user.

The term “additional inputs from the user” refers to subsequent text or interaction data provided by the user after initial data entry, such as updates to inventory, changes in preferences, or feedback regarding previously proposed cooking-plan candidates.

The term “updated contents” refers to revised food information or preference information that has been changed or added based on additional inputs from the user.

The term “repeatedly propose” refers to the processor's operation of performing prompt generation, model invocation, and result presentation multiple times over a period, in response to changes in stored data or user interactions, rather than only once.

The term “evaluation information” refers to explicit user-provided assessments of a cooking-plan candidate or a cooking-procedure candidate, such as ratings, approval indications, or selection of preferred options.

The term “comment information” refers to free-form textual feedback or remarks provided by participants regarding cooking-plan candidates, cooking-procedure candidates, or related system outputs.

The term “subsequent processing” refers to later operations performed by the processor after prior interactions, including future prompt generation, model execution, or result formatting that can be influenced by earlier evaluation or comment information.

The term “dialogue-history information” refers to accumulated message data, including user utterances, system outputs, and reactions, that have been exchanged in the group communication screen over time.

The term “interest-area information” refers to generalized topics or thematic categories inferred from dialogue-history information, such as travel, leisure, or particular types of cuisine, representing areas in which participants show sustained or repeated interest.

The term “candidate information related to outside activities or leisure activities” refers to generated data describing potential events, services, or plans related to non-daily or recreational activities, which may be proposed to participants via the message-processing application.

The term “related services” refers to additional commercial or non-commercial offerings, such as travel arrangements, event participation, or experience-based services, that are associated with or suggested based on participants' interest-area information.

In one embodiment, a server executes a menu planning and inventory management application on general-purpose computing hardware. The server includes at least one multi-core central processing unit, a main memory, a non-volatile storage device such as a solid-state drive, and a network interface controller connected to a packet-switched communication network. The server executes an operating system such as a general-purpose server operating system and runs middleware including a web server, an application server framework, and a database management system, for example an HTTP server, an application framework implemented in a general-purpose programming language, and a relational database engine such as a relational database system.

A terminal executes a message-processing application on user-side hardware such as a smartphone, a tablet, or a personal computer. The terminal includes a central processing unit, random access memory, non-volatile storage, a display device, an input device such as a touchscreen, and a wireless or wired communication interface supporting protocols such as Wi-Fi, cellular data, or Ethernet. The terminal executes a mobile or desktop operating system and runs a messaging application that provides a group communication screen to users.

A user operates the terminal to input natural-language text in the group communication screen, including descriptions of food items stored in a storage apparatus and descriptions of dietary preferences and restrictions. The terminal converts user manipulations on the input device into digital text data and transmits the text data to the server through an application programming interface provided by the message-processing application platform.

The server receives message payloads from the message-processing application platform through an incoming webhook interface exposed by the web server. The server parses transport-level headers and message bodies and passes normalized JSON or equivalent structured data into an application layer. The server stores the raw text content and message metadata, including group identifiers, user identifiers, and timestamps, in a message log table of the relational database. The server then invokes a text analysis module that performs natural-language processing on the text content.

The server uses an item-extraction module to identify food item candidates in the user messages. The item-extraction module is implemented as a hybrid system combining rule-based patterns, dictionary lookup tables, and a statistical sequence-labeling model. The server loads a vocabulary of food-related terms and ingredient names into memory from a configuration table of the database. The server tokenizes incoming text using a tokenizer that segments the text into tokens, applies part-of-speech tagging, and applies a named entity recognition model trained to label tokens with an “ingredient” tag. The sequence-labeling model can be implemented as a bidirectional recurrent neural network or a transformer-based encoder, trained on annotated corpora of recipe texts and grocery item descriptions. The server applies this model to the token sequence and obtains probability scores for each token being part of a food item phrase. The server then groups adjacent ingredient-labeled tokens into candidate item phrases and filters them using confidence thresholds and dictionary validation.

The server normalizes the extracted food item candidates into identifier information representing generalized item categories. The server performs lowercasing, diacritic removal, and lemmatization, and then maps the normalized phrases to canonical item identifiers stored in an item master table. For example, the server maps the phrases “eggs” and “egg” to a canonical identifier representing “egg,” and maps the phrases “whole milk” and “milk” to a canonical identifier representing “milk.”

The server stores the canonical identifiers, together with optional quantity estimates and expiration dates if present in the text, into an item-information storage region of the database, for example a table with fields for group identifier, item identifier, quantity, expiration date, and timestamps. By converting unstructured text into canonical identifiers, the server ensures that subsequent computations can efficiently perform equality comparisons and aggregate queries without ambiguity, which improves data consistency and reduces computational overhead for inventory comparison.

The server uses a separate preference-analysis module to convert natural-language preference information and intake-restriction information into structured attribute information. The server applies a multi-stage pipeline that includes keyword extraction, phrase pattern matching, and classification with a small multi-label classifier neural network. The server loads a list of known dietary styles (for example, vegetarian, vegan, pescatarian), known dietary constraints (for example, low-carbohydrate, low-fat, low-sodium), and known allergens (for example, nuts, dairy, gluten) from a configuration region of the database. The server searches user messages for occurrences of these terms and assigns them to attribute slots. In addition, the server uses a classifier model, such as a feedforward neural network with a softmax or sigmoid output layer, trained on labeled examples of preference sentences, to detect implied preferences even when users do not use exact keywords. The server converts recognized preferences and restrictions into a normalized record structure with fields such as diet_type, carb_level, allergy_flags, and acceptable_ingredient_categories, and stores these records in a preference-information storage region of the database keyed by user identifier and group identifier. This data structuring improves precision and recall of dietary constraint handling and avoids repeated parsing of historical messages, thereby improving processing speed.

The server constructs a prompt sentence for a generative AI model based on the normalized item information and the structured preference information. The server uses a prompt-construction module implemented in the application layer to pull the current state of the group's inventory and preferences from the database. The server executes structured queries on the item-information storage region to obtain a list of active items that are not expired, and executes structured queries on the preference-information storage region to obtain a consolidated view of active preferences and restrictions of the participants.

The server assembles these data into a constrained textual template that guides the behavior of the generative AI model. The server includes in the prompt explicit lists of available ingredients, explicit descriptions of each participant's constraints, and explicit rules for output formatting. For example, the server may generate a prompt sentence such as:

“You are a professional cooking assistant. Based on the following available ingredients in the fridge: eggs, milk, tomatoes, spinach, and tofu. There are two participants: User A is vegetarian. User B must follow a gluten-free diet. Suggest 3 dinner recipes that satisfy both users' dietary requirements. For each recipe, provide: 1) recipe name, 2) short description, 3) full list of ingredients with quantities, 4) step-by-step cooking instructions, and 5) estimated cooking time. Use simple language and avoid ingredients that are not in the fridge except basic seasonings like salt, pepper, and oil.” In another example, the server may generate the prompt sentence:

“Using these ingredients: eggs, tomatoes, and cheese, and considering that the user is vegetarian and wants a low-carb dinner, suggest 2 simple recipes that can be cooked in under 20 minutes. For each recipe, list the required ingredients, the number of servings, and step-by-step instructions.”

The server enforces a deterministic prompt construction algorithm that systematically orders items, normalizes units, and includes explicit constraints. Because the server converts all relevant internal state into a controlled textual form before communicating with the generative AI model, the server can reproduce or audit past model calls by storing the exact prompt text together with the model parameters in the database. This improves traceability and makes model behavior more predictable, which is a technical improvement over ad hoc manual prompt creation.

The server interacts with a generative AI model that is implemented as a large-scale neural network with a transformer architecture. The generative AI model is deployed either as a remote service accessible via HTTPS or as a local inference service running on a graphics processing unit server. The model includes an embedding layer that converts tokens of the prompt sentence into numeric vectors, multiple layers of self-attention and feedforward networks that process token sequences, and an output projection layer that produces probability distributions over a fixed vocabulary for each next token. The server provides configuration parameters to the model such as maximum generation length, temperature, top-k or top-p sampling parameters, and stop conditions to control output size and diversity.

In a local deployment embodiment, the server or an associated inference node loads model parameters from non-volatile storage into GPU memory and executes forward passes for each prompt. The model is trained beforehand on large corpora of recipe texts and general natural-language data using a supervised or self-supervised learning procedure. The training process includes defining a loss function such as cross-entropy between predicted token distributions and reference tokens, computing gradients of the loss with respect to model parameters using backpropagation, and updating the model parameters using an optimization algorithm such as stochastic gradient descent or Adam. Data augmentation methods such as synonym substitution and random ingredient reordering can be used during training to improve robustness in cooking and ingredient contexts.

The server leverages the generative AI model not only as an oracle but as a configurable component. Because the server structures prompt sentences and constraints in a consistent way, the server can adapt model behavior to different group profiles by modifying the prompt composition logic, without modifying the model weights. This decoupling improves maintainability and makes it possible to adjust system behavior through database-stored rules and templates, which is a technical advantage.

The server receives output text from the generative AI model and stores the complete generation result, along with the prompt sentence, model identifier, and parameter settings, into a generated-results table. The server then formats the content for presentation in the message-processing application environment. The server parses the text to identify recipe titles, ingredient lists, and numbered steps, for example using regular expressions or a small parser trained on model outputs.

The server inserts appropriate line breaks, numbering, and bullet markers that conform to the message-processing application's interface specification and message-length limits. By performing this post-processing at the server, individual terminals do not need to implement complex formatting logic, reducing client-side resource usage and ensuring consistent presentation across devices.

The server also integrates the AI-generated results with the inventory and ordering logic. The server extracts the set of required ingredients from each generated recipe. In some embodiments, the server uses the same item-extraction and normalization module that is used for parsing user messages to parse the ingredient lists in the model output. The server maps each ingredient phrase in the generated recipes to canonical item identifiers and compares them with the canonical item identifiers in the item-information storage region. For each canonical identifier, the server computes whether the available quantity meets or falls short of the quantity required by the cooking plan. The server aggregates shortages into a list of missing components.

The server constructs an order data structure comprising the missing component identifiers, desired quantities, delivery address information, and user or group identifiers. The server then communicates this order data structure to an online transaction processing system via an authenticated API call. The online transaction processing system performs order placement and passes fulfillment instructions to distribution processing means such as logistics servers and delivery management systems. Because the server uses canonical identifiers and normalized quantities, the mapping from recipe ingredients to commercial product codes can be performed efficiently via precomputed cross-reference tables, reducing ordering errors and improving processing speed.

The server continuously updates the stored item and preference information in response to additional inputs from users. When a user reports that certain ingredients have been consumed, the terminal sends a corresponding message, and the server adjusts quantity fields in the item-information storage region. When a user updates dietary preferences or reports new allergies, the server updates the corresponding structured attribute records. The server takes these updates into account in subsequent prompt sentence generation and recipe selection. For example, when a user sends a new message saying “I can no longer eat dairy,” the server updates the preference records to mark dairy ingredients as disallowed and adds explicit constraints in future prompt sentences, such as “avoid all dairy products including milk, cheese, and butter.” This dynamic adjustment allows the system to adapt model inputs as the group state changes, rather than relying on static configuration.

The server also processes feedback and evaluation information from participants. When a user reacts to a recipe with a positive or negative textual comment, the server parses the comment with a sentiment analysis module that uses a classifier neural network trained to output a sentiment score and a relevance score. The server stores these scores along with the recipe identifier and user identifier. The server then modifies future prompt sentences by including references to past successes or failures, for example: “Do not propose recipes similar to the previously rejected dish that contained too much spice,” or “Prefer recipes similar to the previously liked vegetarian tomato egg skillet.” In this way, the server uses structured feedback to guide the generative AI model through the prompt sentence, rather than retraining the model for every user, which is more efficient and avoids costly weight updates.

The terminal and the server cooperate to provide low-latency, high-throughput operation. The terminal handles only basic tasks of capturing user input, rendering text, and sending and receiving messages. All heavy computations for natural-language processing, database operations, prompt construction, and model invocation are performed on the server. This division of labor reduces computational requirements and power consumption on the terminal while enabling centralized optimization of algorithms and data storage. Furthermore, the server caches frequently used prompt skeletons and partial model outputs in memory, and can reuse them when the group context and ingredient lists change only slightly, thereby reducing the number of full model invocations and lowering communication and computation load.

The described architecture improves computer technology in multiple ways. By systematically converting unstructured chat messages into canonical identifiers and structured attribute records in dedicated storage regions, the server enhances data integrity, enables efficient indexing and querying, and reduces the complexity of subsequent computations. By algorithmically composing and reconfiguring prompt sentences based on current database state, feedback, and constraints, the server provides a deterministic interface to a non-deterministic generative AI model and achieves reproducible behavior. By integrating model output with structured comparison and automated ordering mechanisms, the server closes the loop between high-level language understanding and low-level transaction processing, which conventional systems do not do in a unified control flow. These technical features result in improved processing speed, reduced manual intervention, lower error rates in recipe selection and ingredient ordering, and more efficient use of communication and computation resources.

In alternative embodiments, the server can use different machine learning architectures for the item-extraction and preference-analysis modules, such as convolutional neural networks, gradient-boosted decision trees applied to n-gram features, or hybrid rule-learning systems. The generative AI model can be replaced by a smaller domain-specific model trained solely on cooking data if resource constraints require. In another variation, the message-processing application can be implemented as a web-based client instead of a native application, and the communication protocols can use WebSockets instead of HTTPS for push updates.

The user, the terminal, and the server may participate in additional workflows, such as analyzing dialogue-history information to identify interest areas beyond cooking, for example travel or leisure activities mentioned frequently in chat messages. The server applies topic modeling or clustering algorithms to the dialogue history and identifies topics with high relevance scores. The server then constructs separate prompt sentences for the generative AI model to generate suggestions for related services. Because the server analyzes dialogue data in a structured and topic-oriented manner and uses normalized representations, the server reduces noise and focuses computational resources on the most relevant content, which improves the quality and efficiency of service proposals.

By implementing these specific modules, data structures, and processing flows on concrete hardware platforms and within defined software frameworks, the system provides a practical, repeatable way to carry out the claimed invention and achieves technical improvements in data processing, natural-language interaction, and integration of generative AI models with inventory and ordering subsystems.

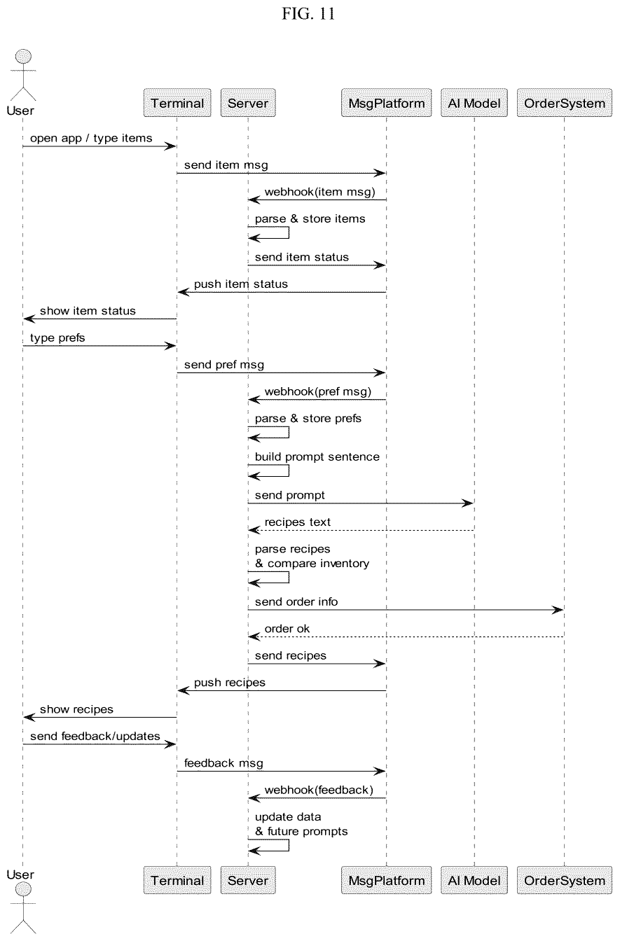

The following describes the processing flow using FIG. 11.

### Step 1:

The user operates the terminal to launch the message-processing application and open a group communication screen.

The terminal loads the messaging application into memory, establishes a network session with a messaging platform server, and displays the group chat interface.

Input: none (initial user action).

Output: a rendered group communication screen on the terminal, ready to accept user text input.

### Step 2:

The user operates the terminal to input natural-language text describing food items stored in a storage apparatus, for example: “We have eggs, milk, and tomatoes in the fridge.”

The terminal converts keystrokes or touch inputs into a character string, packages the string into a message object including metadata such as group ID and user ID, and transmits the message object to the messaging platform over a network connection.

Input: user keystrokes or speech input.

Output: a structured message payload containing text information and metadata sent from the terminal to the messaging platform.

### Step 3:

The server receives, via a webhook interface, the structured message payload from the messaging platform.

The server parses HTTP headers and the body, extracts the text content, group identifier, and user identifier, and stores the raw message and metadata into a message log table in a database.

Input: structured message payload including text “We have eggs, milk, and tomatoes in the fridge” and associated identifiers.

Output: stored log entries in the database and an in-memory representation of the message ready for further processing.

### Step 4:

The server executes an item-extraction module on the received text content to identify food item candidates.

The server tokenizes the text into word tokens, uses a part-of-speech tagger and an ingredient-recognition model to assign an “ingredient” label to relevant tokens, groups adjacent ingredient-labeled tokens into phrases such as “eggs,” “milk,” and “tomatoes,” and filters out non-ingredient tokens.

Input: raw text string from the message (e.g., “We have eggs, milk, and tomatoes in the fridge”).

Output: a list of food item candidate phrases, for example [“eggs”, “milk”, “tomatoes”].

### Step 5:

The server performs normalization and canonical mapping of the extracted food item candidates.

The server converts each candidate phrase to lowercase, removes plural suffixes and diacritics, and uses a lookup table in the database to map each normalized phrase to a canonical item identifier, for example mapping “eggs” to “egg” and “tomatoes” to “tomato.”

Input: list of food item candidate phrases [“eggs”, “milk”, “tomatoes”].

Output: a list of canonical item identifiers and normalized names, for example [{id: EGG, name: “egg”}, {id: MILK, name: “milk”}, {id: TOMATO, name: “tomato”}].

### Step 6:

The server stores the normalized item data into an item-information storage region of the database.

The server creates or updates records keyed by group identifier, writing fields for item identifier, normalized item name, quantity (if available), expiration date (if available), and timestamps; if records already exist for the same group and item, the server updates quantities instead of inserting duplicates.

Input: canonical item identifiers, group identifier, and timestamp.

Output: persistent item-information records associated with the group in the database.

### Step 7:

The server retrieves the current inventory state for the group and prepares a status message for the participants.

The server queries the item-information storage region for all active items linked to the group identifier, concatenates their normalized names into a human-readable list, such as “eggs, milk, tomatoes,” and constructs a text summary like “Current fridge items: eggs, milk, tomatoes.”

Input: group identifier associated with the incoming message.

Output: a formatted inventory status text string representing the group's shared item state.

### Step 8:

The server transmits the inventory status message back to the group via the messaging platform.

The server builds a response payload containing the group identifier and the formatted status text and sends the payload to the messaging platform API, which forwards it to all participants' terminals.

Input: formatted inventory status text string.

Output: delivery of the inventory status text to each participant's terminal for display in the group communication screen.

### Step 9:

The user operates the terminal to input natural-language text describing preferences and intake restrictions, for example: “I am vegetarian and I am on a low-carb diet.”

The terminal converts the user's input into a text string, wraps the string and metadata into another message payload, and transmits the payload to the messaging platform.

Input: user keystrokes representing preference and restriction information.

Output: a structured preference message payload sent from the terminal to the messaging platform.

### Step 10:

The server receives the preference message payload via the webhook interface and isolates the preference-related text.

The server parses the payload, extracts the text “I am vegetarian and I am on a low-carb diet,” identifies the message type as preference information based on message context or simple classification, and stores the raw text in the message log together with user and group identifiers.

Input: structured preference message payload from the messaging platform.

Output: stored raw preference text and an in-memory representation flagged as preference content.

### Step 11:

The server executes a preference-analysis module to convert natural-language preference text into structured attribute information.

The server scans the text for known dietary terms such as “vegetarian” and “low-carb,” classifies the message using a multi-label classifier to confirm diet type and carbohydrate preference, and constructs a structured record with fields such as diet_type=“vegetarian” and carb_level=“low.”

Input: preference text string “I am vegetarian and I am on a low-carb diet.”

Output: a structured preference record, for example {user_id: U, diet_type: VEGETARIAN, carb_level: LOW, allergy_flags: [ ]}.

### Step 12:

The server stores the structured preference record in the preference-information storage region of the database.

The server either inserts a new record for the user and group or updates an existing record, ensuring only the latest preference and restriction state is used for future computations.

Input: structured preference record and corresponding user and group identifiers.

Output: persistent preference and intake-restriction data stored in the database.

### Step 13:

The server determines that sufficient item and preference information exists to generate a recipe suggestion using a generative AI model.

The server checks the item-information storage region for at least one item and the preference-information storage region for at least one active record for the group; if both are present, the server marks the group context as eligible for recipe generation.

Input: database state containing item and preference records for the group.

Output: a decision flag indicating that a generative AI model should be invoked for this group.

### Step 14:

The server retrieves the relevant item and preference information for prompt composition.

The server queries the item-information storage region to obtain a list of available ingredients, such as [“egg”, “milk”, “tomato”, “spinach”, “tofu”], and queries the preference-information storage region to obtain all active preference records, such as {User A: vegetarian} and {User B: gluten-free}.

Input: group identifier and decision flag to request recipe generation.

Output: an in-memory collection of canonical item names and structured preference attributes for all participants.

### Step 15:

The server constructs a detailed prompt sentence for the generative AI model using the retrieved data.

The server inserts the list of available ingredients and the structured preference attributes into a template to form a natural-language instruction, for example:

“You are a professional cooking assistant. Based on the following available ingredients in the fridge: eggs, milk, tomatoes, spinach, and tofu. There are two participants: User A is vegetarian. User B must follow a gluten-free diet. Suggest 3 dinner recipes that satisfy both users' dietary requirements. For each recipe, provide: 1) recipe name, 2) short description, 3) full list of ingredients with quantities, 4) step-by-step cooking instructions, and 5) estimated cooking time. Use simple language and avoid ingredients that are not in the fridge except basic seasonings like salt, pepper, and oil.”

Input: canonical ingredient list and structured preference attributes.

Output: a single prompt sentence (or multi-sentence prompt text) precisely describing constraints and output format.

### Step 16:

The server transmits the constructed prompt sentence to the generative AI model and obtains a generation result.

The server sends the prompt text and control parameters (maximum length, temperature, and stop criteria) via an API request to a generative AI model endpoint, waits for the model to perform sequence generation on GPU hardware, and receives a text response that includes multiple cooking-plan candidates and corresponding cooking-procedure candidates.

Input: prompt sentence text and generation control parameters.

Output: AI-generated text representing at least one cooking-plan candidate and one cooking-procedure candidate.

### Step 17:

The server parses and structures the AI-generated recipes into a representation suitable for inventory comparison and display.

The server analyzes the generated text, splits the text into distinct recipes, extracts recipe names, ingredient lists, and step-by-step instructions using text parsing or simple pattern rules, and stores the structured recipes into a generated-results table together with the original prompt sentence and model identifier.

Input: AI-generated text containing recipes and instructions.

Output: structured recipe objects and logged generation metadata in the database.

### Step 18:

The server performs ingredient comparison between each generated recipe and the stored inventory data to determine missing components.

The server passes each recipe's ingredient list through the item-extraction and normalization module, obtains canonical item identifiers for required ingredients, and compares required quantities to stored quantities in the item-information storage region; for each ingredient where required quantity exceeds available quantity, the server marks a shortage and aggregates all shortages into a missing-components list.

Input: structured recipe objects and canonical inventory records.

Output: a list of missing components for each recipe, with canonical identifiers and required additional quantities.

### Step 19:

The server creates order information for the missing components and sends the order information to an online transaction processing system.

The server constructs an order record including missing component identifiers, computed quantities, user or group identifiers, delivery address data, and payment-related tokens, and transmits this record using a secure API; the online transaction processing system acknowledges receipt, and the server stores the order identifier and status in an order-history table.

Input: list of missing components with quantities, plus user and delivery metadata.

Output: order information transmitted to an external ordering system and a stored order reference in the local database.

### Step 20:

The server formats the AI-generated recipes into a text format compatible with the message-processing application and includes optional indicators for missing or auto-ordered items.

The server converts the structured recipes into readable text with numbered steps, bullet-point ingredient lists, and annotations such as “(ordered)” next to automatically ordered ingredients, and ensures the overall length and layout comply with the messaging platform's interface specification.

Input: structured recipes and missing-component information.

Output: one or more formatted text messages ready to be displayed in the group communication screen.

### Step 21:

The server transmits the formatted recipe messages to the group via the messaging platform.

The server constructs response payloads containing the group identifier and the formatted recipe texts, sends these payloads to the messaging platform, and triggers the platform to push the messages to all participants' terminals.

Input: formatted recipe text messages.

Output: multiple recipe messages delivered to participants and available for rendering on each terminal.

### Step 22:

The terminal receives the recipe messages and displays them to the user.

The terminal decodes incoming message payloads, passes the text contents to the messaging application's user interface, and renders recipe titles, ingredient lists, and step-by-step instructions in the group communication screen.

Input: recipe message payloads from the messaging platform.

Output: visual presentation of cooking-plan candidates and cooking-procedure candidates on the terminal display.

### Step 23:

The user reviews the displayed recipes and optionally provides additional input regarding inventory changes, preferences, or feedback.

The user reads the recipes on the terminal and may send follow-up messages such as “We used all the eggs,” “I liked the tomato tofu stir-fry,” or “Please suggest something quicker.” The terminal transmits these messages as new payloads, which the server receives and uses to update inventory records, preference records, and future prompt sentences as described in earlier steps.

Input: user feedback and update messages.

Output: new message payloads that trigger updates to item information, preference information, and subsequent generative AI model interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recipe recommendation and online ordering systems typically treat ingredient lists, user preferences, and shopping functions as independent features. As a result, such systems often rely on static rule-based logic or simple search functions, and do not effectively use conversational interfaces or advanced machine learning models to generate context-aware cooking proposals. Furthermore, existing systems generally require users to manually re-enter ingredient data into separate applications, leading to redundant data entry, inconsistency between actual inventory and digital records, and a fragmented user experience across messaging, recommendation, and ordering platforms.

From a computer technology perspective, these limitations manifest as inefficient data flows between messaging subsystems, inventory management subsystems, and external commerce subsystems. Structured data reflecting refrigerator inventory, household preferences, and dietary restrictions are not consistently normalized or maintained across these subsystems. Generative artificial intelligence models, when used, are often invoked with ad hoc or weakly structured prompts, which prevents systematic reuse of conversational history, user feedback, and learned preferences for incremental improvement of recommendations. In addition, the lack of tight integration between generative AI outputs and inventory data results in increased processing overhead for downstream components that must reconcile proposed recipes with available ingredients and ordering constraints.

Moreover, existing systems do not provide an integrated processing pipeline in which: (i) ingredient data is captured directly through a multi-user communication interface as character information or image information; (ii) such data is normalized and maintained as structured inventory information; (iii) generative AI models are consistently guided by generated prompt sentences that encode inventory, preferences, and dietary restrictions; (iv) the AI outputs are automatically analyzed to determine missing items; and (v) ordering and delivery workflows are programmatically initiated and optimized. Without such a pipeline, computer resources are used in a suboptimal manner, with redundant conversions between unstructured and structured representations, repeated user interactions to correct AI outputs, and manual reconciliation between recipe suggestions and purchasing systems.

There is also a technical challenge in efficiently updating and refining the behavior of the generative AI model and associated logic based on user feedback and observed usage patterns. Conventional systems collect ratings and comments in an unstructured way that is not directly tied into the model input pipeline, which prevents automated, learning-based updates to prompt construction logic and post-processing logic. As a result, the system cannot adapt over time to better reflect nutritional tendencies, evolving preferences, or household-specific constraints, and must rely on static configurations and manual tuning.

Accordingly, there is a need for an improved computer-implemented system that integrates multi-user conversational input, structured inventory management, generative AI model interaction via generated prompt sentences, automated shortage determination, and external ordering and delivery services into a unified processing architecture. Such a system should reduce redundant data transformations, streamline interactions between subsystems, and enable learning-based refinement of menu generation and ordering logic, thereby improving the overall efficiency, responsiveness, and accuracy of the underlying computer technology.

The specific processing by the specific processing unit 290 of the data processing device 12 in Application Example 1 is realized by the following means.

The present invention provides a server comprising a processor configured to control, in a multi-user conversation screen of a communication application operating on a terminal device having a communication function, input by a user of food information and beverage information stored in a cooling storage apparatus as character information or image information, and sharing of the food information and the beverage information with other participating users; to acquire, from the terminal device, preference information and dietary restriction information for each participating user, and store the preference information and the dietary restriction information as structured data in a storage device in association with user identification information; to receive, from the terminal device, the food information and the beverage information in the cooling storage apparatus, normalize the food information and the beverage information as inventory information including an item name and a quantity, and update and manage the inventory information on a per-user or per-household basis; to generate a prompt sentence for input to a generative AI model based on the inventory information, the preference information, and the dietary restriction information, transmit the prompt sentence to the generative AI model disposed externally or internally, and obtain response information including cooking proposal information and cooking procedure information from the generative AI model; to analyze required ingredient information included in the cooking proposal information and the cooking procedure information, compare the required ingredient information with the inventory information to calculate shortage ingredient information, and identify product information corresponding to the shortage ingredient information from product management data; to generate, based on confirmation response information from the user, order information including the product information corresponding to the shortage ingredient information, and transmit the order information to an external merchandise delivery service information processing device so as to initiate automatic purchasing processing and delivery processing; to generate the cooking proposal information and the cooking procedure information as display information for the conversation screen of the communication application, and transmit the display information to the terminal device so as to enable menu selection and cooking assistance through interaction among the participating users; and to collect evaluation information and comment information transmitted from the participating users, and use the collected information as additional input information to the generative AI model so as to update, in a learning manner, generation logic of subsequent cooking proposal information and cooking procedure information. This enables an integrated and technically improved processing pipeline in which conversational input, inventory normalization, generative AI interaction via structured prompt sentences, shortage determination, and automated ordering are executed as coordinated computer operations, thereby reducing redundant data transformations, enhancing consistency between inventory and recipe data, and allowing dynamic refinement of recommendation behavior based on feedback, which collectively improves the efficiency and functionality of the underlying computer system.

The term “system” refers to a combination of one or more hardware devices and software components that cooperate to perform information processing, including at least a processor, a storage device, and one or more communication interfaces.

The term “processor” refers to a hardware processing unit, such as a central processing unit or a microcontroller, which executes computer-readable instructions to perform the functions described herein.

The term “terminal device” refers to an information processing device used by a user, such as a mobile communication device, a tablet device, a portable computer, or a similar computing device, having at least a display, an input interface, and a communication interface.

The term “communication application” refers to executable software on the terminal device that provides a real-time or near real-time exchange of messages among multiple users, including but not limited to text, image, audio, or video messages.

The term “multi-user conversation screen” refers to a user interface provided by the communication application that displays messages exchanged among a plurality of users and provides input fields or controls for sending messages to the group.

The term “user” refers to an individual who operates the terminal device and interacts with the communication application or system functions.

The term “participating user” refers to any user who is a member of a conversation group provided by the communication application and who can send or receive messages in that group.

The term “cooling storage apparatus” refers to a storage apparatus for preserving food and beverages at a reduced temperature, such as a refrigerator or a similar cooling device.

The term “food information” refers to data indicating one or more food items stored or intended to be stored in the cooling storage apparatus, including at least item names, and optionally quantities, categories, or expiration dates.

The term “beverage information” refers to data indicating one or more beverage items stored or intended to be stored in the cooling storage apparatus, including at least item names, and optionally quantities, categories, or expiration dates.

The term “character information” refers to information represented as text data, including alphanumeric characters and symbols, input by the user through a text input interface or derived from recognition of image data.

The term “image information” refers to information represented as digital image data, such as a still image or a sequence of images, captured by an image capture device of the terminal device or otherwise acquired.

The term “preference information” refers to data representing likes, dislikes, cuisine preferences, taste tendencies, or similar subjective preferences relating to meals or food of a user or a household.

The term “dietary restriction information” refers to data representing constraints on food intake for a user or a household, including medical restrictions, allergy information, nutritional limits, religious dietary rules, or other food-related limitations.

The term “user identification information” refers to data that uniquely or pseudo-uniquely identifies a user or household in the system, such as an account identifier, a device identifier, or a group identifier.

The term “storage device” refers to a non-transitory computer-readable medium, such as a semiconductor memory, a magnetic disk, an optical disk, or a solid-state drive, configured to store data and program code.

The term “structured data” refers to data organized according to a predefined schema or format, such as tables, records, fields, or key-value pairs, that enable systematic access and processing by the system.

The term “inventory information” refers to structured data representing current stocks of food items and beverage items associated with at least one user or household, including at least item names and quantities, and optionally units or timestamps.

The term “normalize” refers to processing that converts heterogeneous or unstructured data into a standardized representation, such as mapping various name expressions to a canonical item name and converting units or formats into standardized forms.

The term “generative AI model” refers to a machine learning model, typically implemented as a large-scale neural network, configured to generate text or structured data in response to input data, including prompt sentences provided by the system.

The term “prompt sentence” refers to text or structured content constructed by the system and provided as input to the generative AI model, the content encoding at least inventory information, preference information, and dietary restriction information, and optionally instructions regarding output format.

The term “response information” refers to data output by the generative AI model in response to a given prompt sentence, including at least cooking proposal information and cooking procedure information.

The term “cooking proposal information” refers to data representing one or more proposed meals or recipes, including at least a recipe title or menu name and an associated list of required ingredients.

The term “cooking procedure information” refers to data representing step-by-step instructions or procedures for preparing a meal or recipe, including operations, order of steps, and optionally timing or temperature parameters.

The term “required ingredient information” refers to data specifying ingredients needed to execute a proposed cooking procedure, including at least ingredient names and required quantities, and optionally units.

The term “shortage ingredient information” refers to data representing ingredients for which the required quantity for a proposed recipe exceeds the available quantity in the inventory information, including at least ingredient names and shortage quantities.

The term “product management data” refers to structured data representing one or more purchasable products, including identifiers, names, categories, sizes, and other attributes, which the system uses to map ingredients to concrete products.

The term “product information” refers to data representing a specific purchasable product corresponding to one or more ingredients, including at least a product name and an identifier, and optionally price and packaging information.

The term “confirmation response information” refers to a user-provided response received via the communication application or another user interface, indicating approval or disapproval of an automatically generated order or proposed action.

The term “order information” refers to data representing a request to purchase one or more products, including at least product identifiers, quantities, and destination information, and optionally payment and delivery details.

The term “merchandise delivery service information processing device” refers to an information processing apparatus operated by a delivery or commerce service provider, configured to receive order information, manage order processing, and manage delivery operations.

The term “automatic purchasing processing” refers to machine-executed operations that, without manual re-entry of product details by the user, generate and transmit order information to a commerce or delivery system.

The term “delivery processing” refers to machine-executed operations that schedule, manage, and track the physical delivery of ordered products to a designated destination associated with a user or household.

The term “display information” refers to data formatted for presentation on a user interface of the terminal device, including layout, text, and control objects for enabling user interaction with cooking proposals and procedures.

The term “menu selection” refers to user input operations by which one or more proposed recipes or meal plans are chosen from among multiple candidates displayed in the communication application or another user interface.

The term “cooking assistance” refers to the provision of instructions, guidance, or contextual information through the user interface to support a user in preparing meals, including recipe steps and optionally tips or adjustments.

The term “evaluation information” refers to data representing a user's evaluation of proposed recipes or system behavior, including but not limited to ratings, scores, or categorical assessments.

The term “comment information” refers to free-form or semi-structured textual or symbolic feedback entered by users, describing impressions, problems, or suggestions regarding the proposed recipes or system operation.

The term “additional input information” refers to evaluation information, comment information, or other feedback-related data that is appended or mapped to subsequent inputs to the generative AI model, beyond the basic inventory, preference, and dietary restriction information.

The term “learning manner” refers to a process in which the system alters one or more parameters, rules, or configurations over time, based on accumulated data including additional input information, so as to improve or adapt the generation logic for later outputs.

The term “generation logic” refers to the combination of rules, parameters, model settings, and prompt construction procedures that determine how the system generates prompt sentences for the generative AI model and how it post-processes the model's responses.

The term “character recognition processing” refers to a computational process that converts text appearing in image information into machine-readable character information, using pattern recognition or machine learning techniques.

The term “code recognition processing” refers to a computational process that detects and decodes coded information in an image, such as barcodes or matrix codes, to obtain structured product or item identifiers.

The term “nutritional intake tendency” refers to a pattern or distribution of nutritional elements, ingredients, or meal types consumed or selected over time by a user or household, as inferred from cooking proposal information and feedback.

The term “preference tendency” refers to a pattern of selections or rejections of particular ingredients, cuisines, or meal types by a user or household over time, as inferred from menu selections, evaluation information, and comment information.

In one embodiment, a server, a terminal, and a user cooperate to implement the claimed system. The server includes at least one processor, a main memory, a non-transitory storage device, and a network interface. The terminal includes at least a processor, a display, an input interface, a camera, and a wireless communication module. The user operates the terminal to interact with a communication application and with server-side functions.

The terminal executes a communication application that may be implemented using typical mobile operating system frameworks, such as a messaging client on a smartphone platform. The terminal acquires text input and image input from the user and converts these inputs into digital data suitable for transmission. The terminal uses a network stack (for example, a TCP/IP stack with an HTTPS client) to send structured requests to the server. The terminal renders display information received from the server on the display device and accepts user selections and confirmations through a touchscreen or other input hardware.

The server executes an application program on top of an operating system. The server may use an application framework, such as a web application framework or a remote procedure call framework, to receive and respond to requests from the terminal. The server accesses a database system, such as a relational database system or a document-oriented database system, to persistently store inventory information, preference information, dietary restriction information, and log data relating to generative AI model interaction.

The server uses multiple software components or modules. A communication interface module receives message payloads and file data from the terminal via the communication application's backend or via dedicated APIs. An image processing module applies character recognition processing or code recognition processing to image information received from the terminal. The image processing module may use a trained neural network for optical character recognition, such as a convolutional neural network with sequence decoding, or a barcode recognition algorithm that identifies and decodes one-dimensional or two-dimensional barcodes. The result of this processing is character information that represents one or more food items or beverages.

The server uses a normalization module to map free-form names and quantities into standardized inventory information. The normalization module uses a structured dictionary or product master table in the database and applies string matching algorithms, such as tokenization, case normalization, and approximate string matching (for example, Levenshtein distance), to map various descriptions (such as “mozzarella cheese”, “m. cheese”, or “fresh mozzarella”) to a canonical item entry. The normalization module further converts non-standard quantity expressions into standard units using predetermined conversion rules stored in a configuration table.

The server uses an inventory management module to maintain inventory information on a per-user or per-household basis. The inventory management module stores, in the database, records including at least a user identifier, an item identifier, a normalized item name, a quantity value, a unit, and a last-updated timestamp. The inventory management module updates quantities when new information is received or when consumption is inferred from user selections and ordering events. The inventory management module thereby maintains a consistent, machine-readable snapshot of the contents of the cooling storage apparatus.

The server uses a preference management module to store and update preference information and dietary restriction information. The preference management module maintains structured records that relate each user or household to lists of liked items, disliked items, cuisine preferences, prohibited ingredients, maximum allowed salt or sugar levels, and other constraints. The preference management module may update these fields in response to explicit user input or in response to inferred tendencies derived from historical menu selections and evaluation information.

The server uses a generative AI interface module to construct a prompt sentence and to communicate with a generative AI model. The generative AI model is implemented as a neural network, for example a transformer-based language model with multiple self-attention layers, feed-forward layers, and layer normalization. The generative AI model is trained using supervised learning and possibly reinforcement learning. The generative AI model uses tokenized text as input and generates token sequences as output, where each token represents a unit of natural language such as a word or subword.

The server constructs a prompt sentence by retrieving inventory information, preference information, and dietary restriction information from the database and using a template-based generation algorithm. The prompt sentence is constructed to include: (i) a description of available ingredients with explicit quantities; (ii) a description of user preferences and constraints; (iii) explicit instructions regarding the desired number of recipes, time limits, and style; and (iv) instructions regarding the output structure. The server uses predefined templates stored in a configuration file and fills variable portions of the template with current values fetched from the database.

The server may construct prompt sentences such as:

“The ingredients currently in the refrigerator are: tomato (3 pieces), mozzarella cheese (200 g), and fresh basil (a small bunch). The household has 4 members and prefers simple Italian dishes and low-sodium meals. There are no other dietary restrictions. Please propose one or two dinner menus using these ingredients and basic pantry items such as salt, pepper, and olive oil. For each menu, output a recipe title, a list of ingredients with quantities, and step-by-step cooking instructions. Ensure that the recipes can be cooked in under 30 minutes.”

“The ingredients currently in the refrigerator are: chicken breast, broccoli, carrot, plain yogurt, lemon, and garlic. One household member is lactose-intolerant, and another requires a low-sodium diet. Please propose two dinner menus that satisfy these restrictions. For each menu, provide a title, a detailed list of ingredients (with quantities and units), and numbered cooking steps. Avoid using any additional ingredients that contain lactose or excessive salt.”

“The ingredients in the refrigerator are tomato, cheese, and basil. Suggest a quick recipe that can be cooked in under 15 minutes. Provide the recipe title, required ingredients with quantities, and concise step-by-step instructions.”

The server sends the constructed prompt sentence to the generative AI model via a network interface.

The generative AI interface module performs tokenization of the prompt sentence, maps tokens to vector embeddings, and passes the embeddings through the transformer layers. Each transformer layer applies multi-head self-attention to compute attention scores over the token sequence, aggregates information from context tokens, and passes the results through non-linear feed-forward networks. The generative AI model calculates a probability distribution over possible next tokens at each step and selects or samples tokens according to configured decoding parameters such as temperature and top-k or top-p sampling thresholds.

The server receives the generated tokens from the generative AI model, converts them back into characters, and assembles them into a text output. The generative AI interface module then passes the output to a parsing module. The parsing module applies rule-based parsers and pattern matching to identify recipe titles, ingredient lists, and cooking steps. The parsing module converts ingredient lines into structured required ingredient information including item names, quantities, and units. The parsing module may use the same normalization module to map required ingredient names into canonical inventory items.

The server uses a shortage determination module to compare required ingredient information against current inventory information. The shortage determination module executes set difference and arithmetic subtraction operations to compute shortage ingredient information. For each recipe, the shortage determination module determines whether the current stock satisfies the required quantity, and if not, calculates a shortage quantity. The module then constructs a shortage list that includes at least the canonical item identifier, shortage quantity, and unit.

The server uses a product mapping module to map shortage ingredient information to product information. The product mapping module accesses product management data, which is stored in the database or accessed via an external product catalog API. The product mapping module uses attribute matching, such as matching item category, typical packaging size, and allowed brands, to select one or more suitable products for each shortage ingredient. The product mapping module may apply selection criteria, such as minimizing cost or matching prior user preferences, based on stored purchase history.

The server uses an ordering module to generate order information. The ordering module receives confirmation response information from the terminal. The ordering module constructs an order payload that includes product identifiers, quantities, delivery address, and payment tokens. The ordering module sends this payload to a merchandise delivery service information processing device via a network interface using a defined application protocol such as a REST API over HTTPS. The ordering module receives confirmation messages, such as order identifiers and estimated delivery times, and stores these in the database to maintain a consistent order history.

The server uses a display generation module to transform cooking proposal information and cooking procedure information into display-ready data structures. The display generation module can create text layouts, recipe summaries, and interactive elements such as selectable recipe identifiers. The server sends this display information to the terminal via the communication application's backend or via a push notification mechanism.

The terminal displays recipe titles, ingredient lists, and step-by-step instructions in the communication application's multi-user conversation screen. The terminal may show interactive buttons or selectable options that allow the user to choose a recipe, request additional variations, or approve ordering of missing ingredients. The user interacts with the terminal to read the steps and to perform cooking operations in the real environment, such as using a stove or oven.

The server uses a feedback collection module to process evaluation information and comment information from users. The feedback collection module stores ratings, free-text comments, and selected or rejected recipes in a feedback table. The server further uses a learning configuration module to analyze the feedback data. The learning configuration module may compute statistics, such as acceptance rates for particular combinations of ingredients, and detect patterns in user rejections of certain items or styles.

The server uses the feedback and analytics results to refine generation logic. The server may adjust the templates used for prompt sentence generation, such as reducing the frequency of disliked ingredients or increasing the emphasis on particular cuisines. The server may also adjust model-related parameters, such as temperature or maximum response length, when invoking the generative AI model. In some embodiments, the server feeds aggregated feedback data into a fine-tuning process for the generative AI model, where additional training epochs are performed using supervised learning. The server may use a loss function such as cross-entropy between the model's outputs and target outputs derived from accepted recipes and may update model weights using gradient-based optimization algorithms.

The generative AI model training process may be performed off-line or periodically. The server may use training datasets that combine inventory states, user preferences, prompt sentences, and accepted recipes. The server may apply data augmentation techniques, such as random perturbation of quantities or reordering of recipe steps, to improve model robustness. The server may also use regularization techniques to avoid overfitting and to ensure that the model generalizes across different households and food preferences.

The system improves computer technology by defining and enforcing specific data structures and processing flows that reduce redundant conversions between unstructured and structured formats.

The server normalizes ingredient names and quantities into canonical inventory information once and then reuses this normalized representation across multiple components, including prompt generation, shortage determination, and product mapping. This reduces computational overhead and database storage redundancy compared with systems that repeatedly parse and re-interpret free-form text.

The system further improves processing efficiency by separating template-based prompt construction from generative text generation. The server delegates context-sensitive language generation to the generative AI model while maintaining deterministic control over the structure and content of model input. This modular separation allows the server to change templates or adjust prompts without retraining the core model and reduces the amount of post-processing required to convert model outputs into actionable structured data. This results in reduced latency and lower CPU usage for downstream processing stages.

The integrated pipeline also reduces communication load. The server predicts missing ingredients in a batched manner by processing entire recipes in one pass, instead of issuing separate queries for each item. The server also creates compact order information that references canonical product identifiers rather than transmitting long free-form descriptions. These measures reduce network payload sizes and the number of required round trips between the server and external merchandise delivery service systems.

From a technical standpoint, the system differs from mere automation of human tasks by implementing a coordinated set of algorithmic modules that exploit machine-readable inventory data, learned preferences, and generative modeling to achieve consistent, machine-optimal recipe proposals and ordering decisions. Human users cannot efficiently maintain canonical inventory states across multiple households and cannot manually generate or evaluate thousands of candidate recipes under nutritional and logistical constraints in real time. The generative AI model, guided by structured prompt sentences, can be executed repeatedly and consistently, and its outputs are systematically reconciled with normalized inventory and product data in a manner that reduces errors and inconsistencies.

In another embodiment, the server may deploy the generative AI model locally on specialized hardware such as graphics processing units or tensor processing units. The server may partition the model across multiple devices and use a distributed inference algorithm to reduce response time for large prompts. The server may cache intermediate representations of frequent ingredients or common household patterns in memory, thereby reducing repeated computation for typical queries.

In a further embodiment, the server may adjust scheduling of generative AI requests and database operations to smooth processing load. The server may maintain a queue of incoming menu generation requests and prioritize them based on current server load, user urgency, or external ordering deadlines. The server thereby prevents overload and maintains consistent response times even under heavy usage.

In yet another embodiment, the terminal may execute some recognition or normalization functions locally, for example performing character recognition on captured images using on-device neural networks. The terminal may send only recognized and partially normalized ingredient information to the server, reducing communication bandwidth and server-side processing load. The server may then perform higher-level functions such as cross-recipe shortage determination and product mapping.

Across these embodiments, the server, the terminal, and the user cooperate in a technically structured manner such that the system maintains accurate inventory information, generates prompt sentences tailored to the available data, uses a generative AI model to produce detailed cooking proposal information and cooking procedure information, determines shortage ingredient information, and integrates with ordering and delivery subsystems. As a result, the system achieves improved accuracy in recipe suggestions, reduced latency in generating proposals and orders, and consistent synchronization between real-world refrigerator contents and digital representations, thereby enhancing the overall performance and reliability of the underlying computer technology.

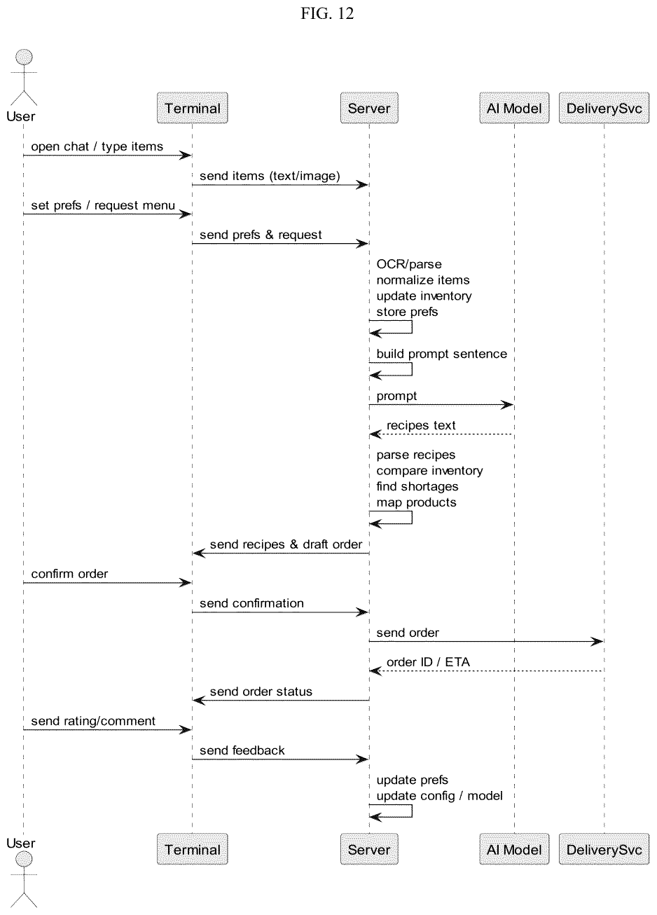

The following describes the processing flow using FIG. 12.

### Step 1:

The user launches the communication application on the terminal and opens a multi-user conversation screen.

The terminal receives, as input, character information typed by the user that describes food information and beverage information stored in the cooling storage apparatus, or image information captured by the terminal camera showing such items.

The terminal converts the character information into encoded text data and the image information into a compressed image format, and outputs a message payload that includes user identification information and the encoded data.

The terminal sends the message payload to the server via a network using a secure communication protocol.

### Step 2:

The server receives, as input, the message payload containing text data and optionally image data from the terminal.

The server analyzes the payload and separates character information, image information, and user identification information.

The server outputs two internal data structures: a text buffer containing any directly entered food information and beverage information, and an image buffer containing captured image information associated with the same user identification information.

### Step 3:

The server receives, as input, the image buffer that contains images of food items, labels, or barcodes.

The server applies character recognition processing to the image buffer by executing an optical character recognition algorithm and applies code recognition processing to detect and decode barcodes or matrix codes.

The server converts the recognized characters and decoded codes into preliminary food information and beverage information, including raw item names and optional quantities, and outputs a preliminary ingredient list as structured text records.

### Step 4:

The server receives, as input, the preliminary ingredient list from character recognition and the text buffer containing user-typed ingredient descriptions.

The server executes normalization processing by performing tokenization, lowercasing, removal of punctuation, and approximate string matching against a dictionary stored in a storage device.

The server maps each raw item name to a canonical item entry, converts any detected quantities into standard units using conversion rules, and outputs inventory information records that include a canonical item name, a quantity, a unit, and the user identification information.

The server receives, as input, the normalized inventory information records and existing inventory information stored in a database for the same user or household.

The server performs data aggregation operations that include summing quantities for identical canonical items and applying update rules based on timestamps or overwrite policies.

The server updates the inventory information table in the database and outputs an updated inventory state associated with the user identification information, including current quantities and last-updated timestamps.

### Step 6:

The user operates the terminal to input preference information and dietary restriction information via a settings screen or conversation interface.

The terminal receives, as input, selected options and free-text descriptions such as preferred cuisines, disliked ingredients, and prohibited items.

The terminal converts these selections into structured preference data linked to the user identification information and outputs a preference payload.

The terminal sends the preference payload to the server using a network protocol.

### Step 7:

The server receives, as input, the preference payload from the terminal.

The server validates the preference information and dietary restriction information by checking allowed value ranges and string lengths, and then writes or updates corresponding records in a user profile table in the database.

The server outputs an updated profile state that associates the user identification information with stored preference information and stored dietary restriction information.

### Step 8:

The user sends, as input, a request message through the communication application on the terminal, such as a request for a dinner suggestion.

The terminal forwards this request message to the server.

The server receives the request, analyzes the message content for intent, and outputs a menu-generation trigger that indicates that a new cooking proposal should be generated for the user or household.

### Step 9:

The server receives, as input, the menu-generation trigger, the updated inventory state, and the updated profile state.

The server queries the database to obtain the current inventory information and the associated preference information and dietary restriction information for the relevant household.

The server composes a data structure that combines available ingredients, quantities, household size, preferences, and dietary restrictions, and outputs a consolidated context dataset for prompt sentence generation.

### Step 10:

The server receives, as input, the consolidated context dataset.

The server applies a template-based generation algorithm that inserts the available ingredient names and quantities, household configuration, and constraints into predefined natural language templates.

The server generates a prompt sentence that explicitly instructs a generative AI model to propose one or more menus, list required ingredients with quantities, and provide step-by-step cooking procedure information under specified time and dietary constraints, and outputs the prompt sentence as a text string.

### Step 11:

The server receives, as input, the prompt sentence and model invocation parameters such as a model identifier and decoding options.

The server tokenizes the prompt sentence into tokens, converts tokens into numeric embeddings, and passes the embeddings to the generative AI model, which is implemented as a transformer-based neural network.

The server causes the generative AI model to compute attention scores, apply feed-forward transformations, and generate a probability distribution for each next token, and decodes a sequence of tokens under the configured decoding strategy.

The server converts the output tokens back into characters and outputs response information as generated text that includes cooking proposal information and cooking procedure information.

### Step 12:

The server receives, as input, the response information generated by the generative AI model.

The server applies a parsing process that detects recipe titles, ingredient list sections, and numbered or ordered cooking steps using pattern matching and syntactic cues in the text.

The server extracts required ingredient information, including item names, quantities, and units, and outputs a structured recipe dataset that includes at least titles, required ingredient information, and cooking procedure information.

### Step 13:

The server receives, as input, the structured recipe dataset and the updated inventory state.

The server performs set comparison and arithmetic operations by matching required ingredient item names to canonical inventory items and subtracting inventory quantities from required quantities.

The server identifies ingredients with negative remaining quantities as shortages and calculates shortage quantities, and outputs shortage ingredient information that lists each missing or insufficient item with a required additional amount.

### Step 14:

The server receives, as input, the shortage ingredient information and product management data from a product catalog stored locally or retrieved from an external system.

The server applies mapping rules and similarity matching to associate each shortage ingredient with one or more candidate products based on attributes such as category, package size, and allowed brands.

The server selects appropriate product information for each shortage ingredient and outputs a mapped product list that ties each ingredient to specific purchasable products.

### Step 15:

The server receives, as input, the mapped product list and generates, as an intermediate output, a draft order proposal that includes product identifiers, quantities, and preliminary delivery information.

The server formats this draft order proposal into human-readable text and interactive elements and sends the formatted proposal to the terminal via the communication application.

The terminal displays the draft order and recipes on the conversation screen.

The user reviews the proposal and provides confirmation response information or modifications through the terminal.

### Step 16:

The terminal receives, as input, the user's confirmation response information, such as approval to order all missing items or a selection of specific items to order.

The terminal converts this input into a structured confirmation payload and outputs the payload to the server through the network interface.

### Step 17:

The server receives, as input, the confirmation payload and the mapped product list.

The server constructs final order information by combining selected product identifiers, quantities, delivery address, and payment tokens associated with the user.

The server outputs the order information in a standardized format and transmits the order information to a merchandise delivery service information processing device using a secure application protocol.

### Step 18:

The merchandise delivery service information processing device processes, as input, the order information received from the server, and generates an order confirmation that includes an order identifier and estimated delivery time.

The merchandise delivery service information processing device sends the order confirmation to the server.

The server receives the order confirmation and outputs a delivery status message to the terminal.

The terminal displays the delivery status message to the user on the conversation screen.

### Step 19:

The server receives, as input, the structured recipe dataset and generates display information that formats recipe titles, ingredient lists, and cooking steps for presentation on the terminal.

The server outputs this display information through the communication application backend to the terminal.

The terminal receives the display information, renders the recipes in the multi-user conversation screen, and enables the user to follow the steps while cooking in the physical environment.

### Step 20:

The user interacts with the terminal to rate the proposed recipes, provide evaluation information, and enter comment information regarding taste, difficulty, or suitability.

The terminal receives, as input, the ratings and comments, converts them into structured feedback data linked to recipe identifiers and user identification information, and outputs the feedback data to the server.

### Step 21:

The server receives, as input, the feedback data including evaluation information and comment information.

The server writes the feedback data into a feedback table in the database and associates it with the corresponding inventory state, prompt sentence, and generated response information that produced the evaluated recipes.

The server performs statistical analysis on accumulated feedback to compute acceptance rates, detect disliked ingredients, and identify preferred cuisines, and outputs updated preference tendencies and nutritional intake tendencies.

### Step 22:

The server receives, as input, the updated preference tendencies and nutritional intake tendencies.

The server updates the preference information and dietary restriction information in the user profile to reflect implicit preferences inferred from behavior and feedback.

The server modifies template parameters and model invocation parameters used in prompt sentence generation, such as changing emphasis on certain cuisines or adjusting output length, and outputs updated configuration data that will be used in subsequent prompt sentence generation.

### Step 23:

The server optionally receives, as input, batches of historical prompts, responses, and feedback data when performing periodic retraining or fine-tuning of the generative AI model.

The server constructs training examples that pair prompt sentences with target outputs derived from accepted recipes, computes a loss function such as cross-entropy between model outputs and target outputs, and updates model weights using gradient-based optimization algorithms.

The server outputs an updated generative AI model with refined parameters and deploys the updated model for future inference requests, thereby improving the quality and relevance of subsequent response information generated for new prompt sentences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented meal planning systems generally operate in a one-directional manner: they retrieve static recipe data from a data store, apply simple rule-based filtering according to user allergies or calorie targets, and display a list of candidate recipes. Such systems typically do not leverage multi-user conversational environments, do not dynamically reflect evolving user preferences based on rich natural-language feedback, and do not coordinate with external service systems in a seamless, automated way. As a result, these systems suffer from several technical limitations.

First, conventional systems do not provide an integrated data flow that connects real-time inventory information from storage apparatuses, such as refrigerators or freezers, with conversational user interfaces. Inventory acquisition is often manual, fragmented, or outside the main communication channel, causing redundant input operations, inconsistent data formats, and inefficiencies in server-side processing. The lack of a unified mechanism to structure and persist inventory data as machine-readable records degrades the accuracy and timeliness of subsequent computations on the server.

Second, existing systems generally treat user preferences and dietary restrictions as static profile fields and do not incorporate fine-grained natural-language feedback into the underlying generative logic. Feedback is often stored as unstructured text or simple ratings without being systematically preprocessed, mapped to model-usable representations, or fed back into a generative AI model. Consequently, the system cannot adaptively evolve its recommendation behavior, and the server cannot improve the quality and relevance of generated meal plans and cooking procedures based on accumulated conversational history.

Third, conventional architectures do not tightly integrate group conversation functions with backend learning workflows. Multiple users may discuss recipes in a shared chat, but the server rarely uses these group comments as structured feedback signals. The conversational layer is treated as a mere presentation channel rather than as a rich, continuous source of training data that can be exploited by a generative AI model. This results in underutilization of available interaction data and prevents the system from optimizing recommendation logic for a group context.

Fourth, in many systems, integration with external product providing systems, such as online ordering platforms, is implemented via simple hyperlink redirection or manual user input. Shortage items identified in the course of meal planning are not automatically derived from structured recipe data and inventory records in a systematic way, and are not programmatically converted into machine-readable product information for downstream systems. This creates friction in the end-to-end workflow and prevents the server from efficiently orchestrating automated ordering operations.

Fifth, from a computer-technology standpoint, existing solutions do not define a coherent server-side pipeline that (i) receives heterogeneous natural-language inputs from terminals in a group conversation, (ii) normalizes and structures such inputs into persistent records, (iii) builds and updates user preference profiles, (iv) composes context-rich prompt sentences for a generative AI model, and (v) performs iterative training or logic updates based on preprocessed feedback. The absence of such an integrated pipeline leads to suboptimal utilization of computational resources, increased latency due to ad hoc data transformations, and duplicated or inconsistent logic across components.

Accordingly, there is a need for a computer-implemented system that improves the way a server collects, structures, and stores user and inventory data within a group conversation environment; that programmatically generates and refines prompt sentences for interaction with a generative AI model; that preprocesses and reuses conversational feedback as learning data to update either the model or prompt-generation logic; and that automatically derives shortage items and interacts with external product providing systems. Such a system should enhance the technical operation of the server, reduce redundant processing, and enable adaptive, higher-quality generation of meal plans and cooking procedures in a multi-user environment.

The specific processing by the specific processing unit 290 of the data processing device 12 in Example 2 is realized by the following means.

The present invention provides a server comprising a processor and a storage device, the processor being configured to receive, via a communication network and a terminal executing an information communication application having a group conversation function, inventory information including types and quantities of food items stored in a storage apparatus as text data from a user, to normalize and register the inventory information in the storage device in association with identification information, to receive, via the group conversation function and the terminal, attribute information including preference information and intake restriction information from the user, to store the attribute information in the storage device in association with the inventory information, to generate and update a user preference profile based on the attribute information, to generate a prompt sentence to be input to a generative AI model based on the inventory information and the preference profile stored in the storage device, to transmit inquiry data including the prompt sentence to the generative AI model via the communication network, to receive natural language text output from the generative AI model in response to the prompt sentence, to parse and extract meal plan information and cooking procedure information from the natural language text, to store the meal plan information and the cooking procedure information as structured data in the storage device, to present the meal plan information and the cooking procedure information to at least one terminal via the group conversation function, to identify, based on at least one of the meal plan information and the cooking procedure information, one or more food items that are not included in the inventory information as shortage items, to generate product information related to the shortage items, to request provision of the shortage items by transmitting the product information to a product providing system via the communication network, to receive, via the terminal, feedback information including evaluation text regarding at least one of the meal plan information and the cooking procedure information from at least one user, to accumulate the feedback information in the storage device, to perform preprocessing on text data included in the accumulated feedback information to generate preprocessed data, to input the preprocessed data to the generative AI model as learning data and to update at least one of the generative AI model and prompt-sentence generation logic such that meal plan information and cooking procedure information subsequently generated by the generative AI model are adaptively evolved to match user preferences, and to share the meal plan information and the cooking procedure information among a plurality of users participating in the group conversation function and collect comments from the plurality of users on the shared information as additional feedback information. This enables an improved computer-implemented pipeline in which the server consistently transforms conversational inputs into structured records, programmatically composes and refines prompt sentences for a generative AI model, adaptively updates model behavior or prompt logic based on preprocessed feedback, and automatically orchestrates downstream interactions with external product providing systems, thereby enhancing the technical performance, scalability, and responsiveness of meal planning and related services in a multi-user conversational environment.

The term “system” refers to a combination of hardware and software components including at least one server, at least one storage device, and one or more terminals interconnected via a communication network and configured to execute the processes described herein.

The term “server” refers to an information processing apparatus comprising at least one processor and at least one storage device, configured to provide backend functionalities including data reception, storage, processing, interaction with a generative AI model, and communication with terminals and external systems.

The term “processor” refers to one or more hardware computing units, such as a central processing unit or an execution core, capable of executing machine-readable instructions to perform arithmetic, logic, control, and input/output operations required to implement the functions described herein.

The term “storage device” refers to a non-transitory computer-readable medium, such as a semiconductor memory, magnetic disk, optical disk, or solid-state drive, configured to store programs, models, parameters, and data including inventory information, attribute information, preference profiles, meal plan information, cooking procedure information, and feedback information.

The term “terminal” refers to a user-operated electronic apparatus, such as a smartphone, tablet computer, personal computer, or similar device, configured to execute an information communication application and to transmit and receive data to and from the server via a communication network.

The term “communication network” refers to a wired or wireless data transmission infrastructure, including but not limited to the Internet, local area networks, cellular networks, or other packet-switched or circuit-switched networks, through which data is exchanged between the server, terminals, and external systems.

The term “information communication application” refers to software executed on a terminal that supports message exchange between users and/or between users and the server, including but not limited to messaging, chat, or collaboration applications.

The term “group conversation function” refers to a function of the information communication application that enables a plurality of users to participate in a shared conversation space, to send and receive messages visible to the group, and to interact with server-generated messages within the same conversation context.

The term “storage apparatus” refers to an appliance or equipment configured to store food items or ingredients under controlled conditions, including but not limited to refrigerators, freezers, or similar devices.

The term “food item” refers to any edible ingredient, product, or material intended for preparation and consumption as part of a meal, including raw ingredients, processed foods, and packaged products.

The term “inventory information” refers to data indicating at least types and quantities of food items currently available in a storage apparatus, and may further include associated attributes such as units, expiration dates, or storage locations.

The term “identification information” refers to data that uniquely or specifically associates records with a user, a group, a storage apparatus, or another entity, such as a user identifier, group identifier, device identifier, or similar key.

The term “attribute information” refers to information related to characteristics of a user or group, including but not limited to preference information and intake restriction information used to personalize generated meal plans and cooking procedures.

The term “preference information” refers to data describing likes, dislikes, preferred cuisines, taste tendencies, or other subjective inclinations of a user or group with respect to meals, ingredients, or cooking styles.

The term “intake restriction information” refers to data describing constraints on consumption for a user or group, including but not limited to allergies, intolerances, medical dietary restrictions, religious restrictions, and nutritional or caloric limits.

The term “preference profile” refers to a structured representation of user or group preferences and restrictions, which may include numerical parameters, categorical attributes, and derived scores used by the server to condition generation of meal plans and cooking procedures.

The term “generative AI model” refers to a machine learning model, such as a neural network-based language model, configured to generate new content, including natural language text, in response to input data or prompts, based on parameters learned from training data.

The term “prompt sentence” refers to a natural language or structured text input composed by the server and provided to the generative AI model to specify context, constraints, and objectives for generating meal plan information and cooking procedure information.

The term “inquiry data” refers to a request payload transmitted from the server to the generative AI model, including the prompt sentence and optionally additional parameters such as generation settings, user identifiers, or contextual metadata.

The term “natural language text” refers to text expressed in a human language that can be read and understood by a human user, and that is generated by or input to the generative AI model.

The term “meal plan information” refers to data describing one or more proposed meals over a period of time, including but not limited to dish names, meal schedules, and associated ingredient requirements.

The term “cooking procedure information” refers to data describing steps, methods, and instructions for preparing and cooking one or more dishes, including ordering of steps, cooking times, temperatures, and specific operations.

The term “structured data” refers to data organized into predefined formats, such as records, fields, tables, or objects, enabling systematic storage, retrieval, and processing by computer programs.

The term “shortage item” refers to a food item required by a meal plan or cooking procedure that is not present, or is present in insufficient quantity, in the inventory information for a storage apparatus.

The term “product information” refers to data describing goods corresponding to shortage items, including identifiers, names, quantities, and other attributes needed by a product providing system to process an order or provision request.

The term “product providing system” refers to an external or separate computer system that manages provision of goods, such as an online ordering platform, retail management system, or logistics management system configured to receive product information and arrange delivery or pickup.

The term “feedback information” refers to data received from a user related to at least one of the meal plan information or the cooking procedure information, including evaluation text, ratings, comments, or similar response data.

The term “evaluation text” refers to natural language text included in feedback information that expresses a user's assessment, opinion, or reaction to a proposed meal or cooking procedure, including qualitative descriptions of taste, difficulty, or satisfaction.

The term “preprocessing” refers to a sequence of computational operations applied to raw text or other data, including cleaning, normalization, tokenization, feature extraction, or labeling, in order to convert the data into a form suitable for input to the generative AI model or other processing modules.

The term “preprocessed data” refers to data that has undergone preprocessing and is represented in a format suitable for machine learning, analysis, or further automated processing.

The term “learning data” refers to data provided to a machine learning model, such as the generative AI model, for the purpose of training, fine-tuning, or updating model parameters or behavior.

The term “prompt-sentence generation logic” refers to program instructions and rules executed by the server to construct, modify, or select prompt sentences for the generative AI model based on current inventory information, preference profiles, feedback information, and other contextual data.

The term “adaptively evolved” refers to a state in which the behavior of the generative AI model or the content of the prompt sentences is modified over time based on accumulated data such that subsequent outputs more closely align with user preferences or system objectives.

The term “pungency tolerance parameter” refers to a value or set of values included in a preference profile that quantitatively or qualitatively represents a user's or group's tolerance for pungent or spicy flavors.

The term “constraint condition” refers to a rule or parameter imposed on generation or selection of outputs, such as a limit on pungency level, ingredient usage, or nutritional content, which is incorporated into a prompt sentence or generation process.

The term “external service information” refers to data describing services provided by systems other than the server, such as travel services, nutrition consulting, or other ancillary offerings, that may be related to or suggested in connection with meal plan information.

The term “additional product information” refers to data describing supplementary goods or items not strictly required to resolve shortage items for a meal plan, but proposed as optional purchases or upsell opportunities related to the meal plan.

The term “comments” refers to messages or textual inputs provided by users in the group conversation function that pertain to meal plans, cooking procedures, or related topics, and that can be collected as additional feedback information.

The term “plurality of users” refers to two or more distinct users each operating a terminal and participating in the group conversation function, whose interactions and feedback may jointly influence the generation and adaptation of meal plans and cooking procedures.

In one embodiment, a server cooperates with one or more terminals operated by users to implement a meal planning system that uses a generative AI model and one or more prompt sentences. The server includes at least one processor, a main memory, a persistent storage device, and one or more communication interfaces. The server is connected to a communication network such as the Internet. The storage device stores executable programs, generative AI model parameters, user data, inventory data, feedback data, and configuration data.

A terminal includes at least one processor, a memory, a display unit, an input unit, and a communication interface. The terminal executes an information communication application that provides a group conversation function. The group conversation function may be implemented by a general-purpose messaging platform client, such as a chat or collaboration application, running on a smartphone, tablet computer, or personal computer.

A user operates the terminal to run the information communication application and to participate in a group conversation room dedicated to meal planning. The user manually inputs natural-language text describing food items stored in a storage apparatus, such as a refrigerator or freezer. The user may, for example, input: “eggs 4, milk 500 ml, tomatoes 2, chicken breast 300 g.” The terminal converts the input text into a structured request, for example a JSON message internally, and transmits the request to the server via HTTPS over TCP/IP.

The server executes a web application framework, such as a server program implemented using a scripting language runtime and a web framework (for example, a Python runtime with a web framework or a JavaScript runtime with a web framework). The server receives HTTP requests sent by the terminal through webhook or API endpoints exposed to the messaging platform. The server parses the HTTP headers and body, extracts the user identifier, chat identifier, timestamp, and the message text, and normalizes the character encoding and line endings.

The server performs data processing on the received message text to convert it into a structured inventory record. The server, for example, uses a natural-language processing library such as a tokenization library or a rule-based parser that applies regular expressions and lexicons to segment the text into tokens, identify candidate ingredient names, and associate numeric values with units.

The server then builds a record including fields such as item_name, quantity_value, quantity_unit, user_id, and created_at, and stores this record in a relational database management system such as a SQL database (for example, PostgreSQL or MySQL), or a document-oriented database. The database defines tables or collections such as “inventory_items,” “user_profiles,” “meal_plans,” “recipes,” and “feedback.”

The server also receives attribute information from the user through the same group conversation function or through a dedicated settings interface provided by the information communication application. The user inputs preference information and intake restriction information, for example: “I like Italian food, I dislike cilantro, no peanuts, and under 600 kcal per meal.” The terminal sends this text to the server. The server performs text normalization (lowercasing, removal of extra spaces), dictionary-based mapping (mapping “Italian” to a cuisine category), and pattern matching to extract explicit restrictions (for example, “no peanuts” to an allergy field). The server stores this attribute information in the “user_preferences” table together with the user identifier.

The server constructs a preference profile for each user. The server uses statistical aggregation and feature engineering to transform user preferences and historical accepted recipes into a numerical preference profile. For example, the server computes real-valued parameters such as spice_tolerance, sweetness preference, fat preference, and a calorie_limit. The server also encodes categorical preferences such as cuisine preferences in a one-hot or multi-hot vector representation. The server stores such parameters and vectors in the “user_profiles” table, either as separate fields or as a serialized vector.

The server uses the stored inventory information and the preference profile to generate a prompt sentence for a generative AI model. The generative AI model may be a large-scale neural network language model implemented as a transformer architecture. In one embodiment, the generative AI model comprises multiple transformer layers, each including multi-head self-attention mechanisms, feed-forward neural networks, layer normalization layers, and learned positional encodings. The model parameters are represented as floating-point weight matrices stored in a model parameter file.

The server may access the generative AI model through an external AI service API or via a local inference engine executed on specialized hardware, such as a graphics processing unit (GPU) with CUDA and a deep learning framework, for example PyTorch or TensorFlow.

The server constructs the prompt sentence by applying a template that combines inventory information, preference profile information, and instructions for the generative AI model. An example of a prompt sentence is:
“You are a meal-planning assistant. The user has the following ingredients: eggs (4), milk (500 ml), tomatoes (2), chicken breast (300 g). The user prefers low-spicy dishes, has a peanut allergy, and wants meals under 600 kcal per serving. Propose a one-day meal plan (lunch and dinner) and provide detailed recipes and cooking steps using only these ingredients and common pantry items (salt, pepper, oil).”

The server prepares a request object containing the prompt sentence, the model name, and generation parameters such as maximum number of tokens, temperature, and top-k or top-p sampling parameters. The server sends this request to the generative AI model endpoint via HTTPS. The generative AI model tokenizes the prompt sentence using a subword tokenizer, maps the tokens to embedding vectors, and sequentially performs matrix multiplications and non-linear activations through its transformer layers to compute a probability distribution over the next token at each generation step. The model generates output tokens according to the probability distribution and the sampling parameters, forming a natural-language text response that describes meal plans and cooking procedures.

The server receives the natural-language output text and performs post-processing. The server detects section headers (such as “Dinner:” or “Ingredients:” or “Steps:”) using pattern matching and regular expressions, and splits the text into structured components. The server then stores the structured data in the “meal_plans” and “recipes” tables, where each recipe record may include fields for recipe_title, ingredient_list, step_list, estimated_time, and associated user_id. The server also stores the raw text output for traceability and later analysis.

The server then transmits the meal plan information and cooking procedure information to the terminals participating in the group conversation. The server uses the messaging platform's API to send messages that contain the recipe titles, ingredients, and steps as plain text, optionally separated into multiple messages for readability. The terminal receives these messages and displays them in the group conversation interface. The user reads the proposed recipes on the display and performs cooking operations in the physical world using the recommended ingredients and steps.

The server further uses the structured recipe data and the current inventory data to identify shortage items. The server computes the difference between the required quantities of each food item in the recipe and the available quantities recorded in the “inventory_items” table. For any item where the required quantity exceeds the available quantity, the server determines a shortage quantity and registers that item as a shortage item. The server then maps the shortage items to product identifiers used by a product providing system, such as an online ordering platform. This mapping is performed by a lookup table stored in the database. The server generates product information records containing product identifiers, quantities, and delivery preferences and submits these records to the product providing system via an API, thereby technically controlling downstream systems to initiate ordering and delivery processes.

The user provides feedback after executing the recipes. The user writes comments in the group conversation, such as “This dish was delicious but still a bit too spicy,” or uses reaction interfaces or rating buttons. The terminal transmits the feedback text and rating data to the server. The server stores the feedback in a “feedback” table, including fields for user_id, recipe_id, rating_value, comment_text, and timestamp.

The server periodically executes a preprocessing pipeline on feedback information. The server uses a text processing library to tokenize the comment_text, remove stopwords if desired, and perform normalization such as stemming or lemmatization. The server also applies rule-based patterns and/or a small classification model to detect taste-related expressions (for example, “too spicy,” “too salty,” “bland,” or “portion too small”). The server encodes these results as labeled data, where input features include recipe attributes and taste expressions, and labels represent user satisfaction categories or specific taste corrections. The server then stores these labeled examples as training or fine-tuning data for the generative AI model.

In one embodiment, the server uses a fine-tuning mechanism provided by an AI service or a locally implemented training loop. The server prepares a dataset of prompt-output pairs and feedback-based corrections and defines a loss function, such as a cross-entropy loss between predicted tokens and ideal tokens, or a preference-ranking loss that encourages outputs with higher user satisfaction. The server runs a gradient-based optimization algorithm, such as stochastic gradient descent or Adam, to update the weight matrices of the generative AI model. During this process, the server adjusts the model's internal representations of flavor preferences, such as reducing the predicted usage of spicy ingredients for a user whose feedback frequently indicates “too spicy.” Alternatively, the server updates prompt-sentence generation logic by adding constraints and reinforcement rules, for example automatically including phrases like “avoid strongly spicy seasonings” for that user.

The server also computes a pungency tolerance parameter for each user or group of users based on accumulated feedback. The server maps detected expressions related to pungency to a numeric scale, aggregates them over time, and writes the resulting parameter into the preference profile. When constructing a new prompt sentence, the server reads the pungency tolerance parameter and automatically inserts a constraint clause. For example, the server generates the following prompt sentence:
“Based on the user's previous feedback that some dishes were too spicy, create a one-day meal plan that is clearly mild. Use only the ingredients in the fridge: eggs, milk, tomatoes, chicken breast, and basic pantry items. Avoid chili peppers and strong hot spices. Provide detailed recipes and cooking steps.”

By explicitly encoding internal preference parameters into the prompt sentence, the server causes the generative AI model to produce outputs that are more aligned with user preferences, while still using a general-purpose generative architecture. This design improves recommendation accuracy and reduces the need for manual corrections by users.

The server collects comments from multiple users in the group conversation as additional feedback information. When several users respond to a recipe with differing opinions, the server stores each comment separately and associates it with the corresponding user_id and recipe_id. The server can then derive group-level parameters, such as an average pungency tolerance or preferred portion size for a household, by aggregating the individual parameters. This allows the server to generate prompt sentences that reflect group preferences, which differs from simple per-user customization.

From a technical perspective, the described system improves computer operation in several ways.

The server defines explicit database schemas and vector-based preference profiles that enable efficient indexing and retrieval, thereby reducing query latency when constructing new prompt sentences. The preprocessing pipeline and structured representation of feedback reduce noise and redundancy, enabling the generative AI model to learn more effectively from a smaller amount of feedback data. The explicit mapping from generative outputs to shortage items and product information enables automated, consistent interaction with external systems, reducing errors and manual intervention.

The server also reduces overall communication load and processing time by transmitting only compact prompt sentences and structured data to the generative AI model instead of full raw conversation histories. This focused conditioning improves generation speed and reduces the number of tokens processed per request. Furthermore, by updating the model or prompt logic based on feedback, the server reduces the number of unsuccessful or unsatisfactory recommendations over time, thereby reducing repeated interactions and computational waste.

The generative AI model does not merely automate human recipe-writing, but uses internal neural representations and learned associations to generalize across ingredients, cuisines, and taste feedback in a way that is difficult to realize with traditional rule-based systems. The server enforces non-trivial, non-conventional processing steps: mapping group conversation messages to structured, model-usable training data; computing preference parameters, including pungency tolerance, from aggregated feedback; embedding such parameters into future prompt sentences; and coordinating generative outputs with automated shortage-item ordering. These steps collectively create a feedback loop that continuously improves system behavior at the computational level.

In another embodiment, the server uses a locally hosted generative AI model instead of an external AI service. The server deploys the model on a GPU server, loads the model weights from the storage device into GPU memory, and executes inference and training using a deep learning framework. The server may employ mixed-precision computations to reduce memory usage and increase throughput.

The server may also compress or quantize the model weights for faster inference, demonstrating additional technical improvements.

In another embodiment, the server implements different prompt-sentence templates for different households or use cases, and dynamically selects the appropriate template based on context stored in the database. The server may further maintain multiple versions of the generative AI model, for example a base model and a fine-tuned model for low-spice recipes, and select between them according to the user's preference profile. These variations illustrate that the disclosed invention can be realized in multiple configurations while maintaining the core technical effects of structured data management, adaptive prompt generation, and feedback-driven model or logic updates.

By integrating these elements, the server enables a concrete, technical implementation of personalized meal planning that goes beyond abstract data processing. The system improves data structuring, storage, retrieval, and model conditioning processes, thereby enhancing the speed, accuracy, and efficiency of meal recommendation generation and related service orchestration in a multi-user conversational environment.

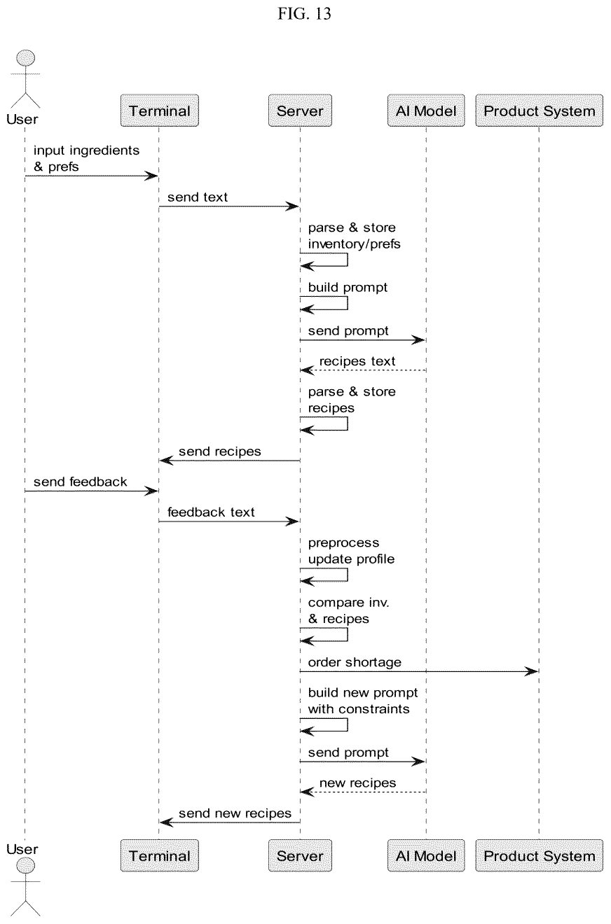

The following describes the processing flow using FIG. 13.

### Step 1:

User operates the terminal to start an information communication application and joins a group conversation room dedicated to meal planning.

User inputs natural-language text describing food items stored in a storage apparatus, such as “eggs 4, milk 500 ml, tomatoes 2, chicken breast 300 g.”

Terminal receives this text as input from the user interface and internally constructs a message object that includes fields such as user identifier, conversation identifier, message text, and timestamp.

Terminal transmits this message object as an HTTP or HTTPS request to the server via the communication network.

The input of this step is the user's free-form text about available ingredients; the output of this step is a structured message object delivered to the server containing the text and associated metadata.

### Step 2:

Server receives the HTTP or HTTPS request from the terminal at a web endpoint implemented by a web framework.

Server parses the request headers and body to extract the user identifier, conversation identifier, and the raw ingredient text.

Server performs data processing by applying tokenization and pattern matching to the raw text to identify ingredient names, numeric quantities, and units. For example, the server splits “chicken breast 300 g” into (“chicken breast”, 300, “g”).

Server normalizes ingredient names using a predefined dictionary (for example, mapping “tomato” and “tomatoes” to a canonical term) and converts quantities to standardized units if necessary.

Server writes the processed records into a database table for inventory items, storing fields such as user_id, item_name, quantity_value, and quantity_unit.

The input of this step is the structured message object from the terminal; the output is a set of normalized inventory records stored in the database.

### Step 3:

User operates the terminal to input attribute information, such as preference information and intake restriction information, for example: “I like Italian food, I dislike cilantro, no peanuts, under 600 kcal per meal.”

Terminal receives this attribute text and encapsulates it in a message object with user identifier and timestamp.

Terminal sends the message object to the server via the communication network.

Server receives the message object as input and performs text normalization, such as lowercasing and trimming whitespace.

Server executes data extraction logic that detects preference keywords (for example, “Italian”) and restriction phrases (for example, “no peanuts”) using rule-based patterns or a small classifier.

Server stores the extracted attributes in a user preference table, associating each attribute with the user identifier.

The input of this step is the attribute text from the user; the output is a structured set of preference and restriction records stored in the database.

### Step 4:

Server aggregates stored inventory information and attribute information for a given user or group.

Server retrieves, from the database, all current inventory items and the corresponding user preference profile, including parameters such as spice_tolerance and calorie_limit.

Server performs data computation to convert inventory items into a human-readable list format and to serialize the preference profile into descriptive phrases.

Server constructs a prompt sentence for a generative AI model by inserting the ingredient list and preference phrases into a predefined template.

For example, the server generates:
“You are a meal-planning assistant. The user has the following ingredients: eggs (4), milk (500 ml), tomatoes (2), chicken breast (300 g). The user prefers low-spicy dishes, has a peanut allergy, and wants meals under 600 kcal per serving. Propose a one-day meal plan (lunch and dinner) and provide detailed recipes and cooking steps using only these ingredients and common pantry items (salt, pepper, oil).”

The input of this step is the structured inventory and preference data; the output is a completed prompt sentence as a text string.

### Step 5:

Server prepares a request payload for the generative AI model, including the prompt sentence, a model identifier, and generation parameters such as maximum number of tokens and temperature.

Server sends this payload via HTTPS to a generative AI model endpoint, which may be hosted externally or locally.

Generative AI model receives the prompt sentence as input tokens and performs internal computations using a transformer-based architecture, including embedding lookup, multi-head attention, and feed-forward layers, to predict output tokens.

Generative AI model outputs a sequence of tokens representing natural-language text that includes meal plan information and cooking procedure information.

Server receives the generated text response as output from the generative AI model.

The input of this step is the prompt sentence and generation parameters; the output is the natural-language text generated by the generative AI model.

### Step 6:

Server processes the generated text to extract structured meal plan and recipe data.

Server applies pattern recognition to the text, detecting sections such as “Lunch:”, “Dinner:”, “Ingredients:”, and “Steps:”.

Server parses these sections into structured data objects that include dish names, lists of ingredients with quantities, and ordered cooking steps.

Server stores these data objects in the database tables for meal plans and recipes, linking them to the corresponding user identifier and conversation identifier.

Server also stores the raw text for reference and potential future analysis.

The input of this step is the generated natural-language text from the generative AI model; the output is structured meal plan and cooking procedure records stored in the database.

### Step 7:

Server sends the structured meal plan information and cooking procedure information to the group conversation as messages suitable for display.

Server formats each recipe as one or more text messages, for example including the recipe title, ingredients, and numbered steps.

Server transmits these messages to the messaging platform's API, which routes them to the terminals of participating users.

Terminal receives the messages as input from the messaging platform and displays them in the group conversation interface.

User reads the displayed information and uses it as guidance for actual cooking operations.

The input of this step is the structured recipe data in the server; the output is visual display of the meal plans and cooking procedures on the terminals.

### Step 8:

Server computes shortage items by comparing recipe ingredient requirements with the stored inventory information.

Server retrieves required ingredient quantities from the recipe records and available quantities from the inventory records for the same user or household.

Server performs arithmetic subtraction of available quantity from required quantity for each item, and for each item where the result is positive, the server marks it as a shortage item and calculates the shortage amount.

Server maps each shortage item to a product identifier using a product mapping table stored in the database.

Server constructs product information objects that include product identifiers, shortage quantities, and delivery or ordering parameters.

Server sends these product information objects to a product providing system via an API in order to request provision of the shortage items.

The input of this step is the structured recipe data and inventory data; the output is a set of product provision requests sent to the product providing system.

### Step 9:

User cooks one or more of the proposed recipes using the real-world ingredients and instructions.

User then operates the terminal to provide feedback, such as “This dish was delicious but still a bit too spicy” or a numeric rating.

Terminal captures the feedback text and rating as input, builds a feedback message object including user identifier, recipe identifier, and timestamp, and sends it to the server.

Server receives the feedback message and stores the feedback text and rating value in the feedback table in the database.

The input of this step is the user's feedback entered via the terminal; the output is a stored feedback record associated with the corresponding recipe and user.

### Step 10:

Server preprocesses feedback information to generate learning data for future adaptation.

Server retrieves newly stored feedback records from the database, focusing on the comment_text and rating_value fields.

Server performs text preprocessing operations on the comment_text, such as tokenization, normalization, and removal of extraneous symbols.

Server applies rule-based patterns or a classification model to detect evaluation expressions, for example “too spicy,” and assigns labels representing taste-related categories.

Server creates training examples that pair input conditions (such as recipe description and preference profile) with labels derived from the feedback, and stores these examples in a training data repository.

The input of this step is the raw feedback text and ratings from the database; the output is preprocessed, labeled data structured for use as learning data.

### Step 11:

Server updates a preference profile and constraint parameters based on the preprocessed feedback.

Server computes aggregate statistics for each user, such as an average rating per spice level, and derives a pungency tolerance parameter by mapping detected “too spicy” expressions to a numeric scale.

Server updates the user's preference profile record with the new pungency tolerance parameter and any other inferred parameters.

Server modifies prompt-sentence generation rules to automatically add constraints based on the updated profile, for example inserting phrases like “avoid spicy food” or “use only mild seasonings” into future prompt sentences.

The input of this step is the preprocessed feedback and existing preference profiles; the output is updated preference profiles and updated prompt-generation rules stored in the server.

### Step 12:

Server optionally fine-tunes or otherwise adapts the generative AI model using the accumulated learning data.

Server constructs a fine-tuning dataset composed of prompt-output pairs and feedback-derived corrections, and defines a loss function to measure mismatch between desired outputs and model outputs.

Server executes a training process on dedicated hardware, such as a GPU, to perform gradient descent on the model parameters.

Server updates the model parameters to minimize the chosen loss function, thereby adjusting the generative behavior toward user-preferred outputs, for example reducing the likelihood of generating spicy recipes for low-pungency profiles.

Server deploys the updated model for subsequent inference requests.

The input of this step is the training data and the current model parameters; the output is an updated generative AI model with modified parameters.

### Step 13:

Server generates new recommendations using the updated preference profiles and, optionally, the adapted generative AI model.

Server retrieves current inventory information and updated preference profiles, constructs refined prompt sentences that include explicit constraints such as “avoid chili peppers and strong hot spices,” and sends these prompt sentences again to the generative AI model.

Generative AI model produces new meal plan and cooking procedure texts according to the improved conditioning.

Server processes and stores these new outputs and sends them to the terminals as described in earlier steps.

User views and uses the new recommendations, and the cycle of feedback and adaptation continues. The input of this step is updated preference data and, optionally, an updated model; the output is a new set of meal plan and cooking procedure information that more closely matches user preferences.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented meal recommendation systems suffer from several technical limitations in how user context is modeled, how generative AI is controlled, and how recommendations are adapted over time. First, typical systems treat user inputs such as inventory lists, preferences, and dietary restrictions as isolated parameters and directly feed them to a recommendation engine. Such systems lack a structured mechanism to aggregate heterogeneous data sources—including historical selections and user evaluations—into a unified context that can be effectively consumed by a generative AI model. As a result, the generated meal plans and cooking procedures often ignore important constraints, cause inconsistent outputs, and require repeated manual corrections, thereby increasing network usage, processor load, and user-interface operations. Second, existing systems generally invoke a generative AI model with simplistic or static prompts. They do not dynamically construct prompt sentences in natural language that encode a rich, machine-derived context including inventory data, preferences, intake restrictions, historical feedback, and emotion-derived parameters. Because the generative AI model is not guided by a well-formed, context-sensitive prompt, system resources are wasted on generating irrelevant or suboptimal content, and additional server-side filtering or post-processing is required. This leads to increased latency, redundant computation, and less efficient use of processing and communication resources.

Third, conventional systems do not integrate multimodal emotion analysis in a systematic way into the core data processing pipeline. Even when emotion recognition is available, it is typically used only for cosmetic personalization at the user interface layer, rather than being fed back into the model-control logic and prompt generation logic. As a consequence, the system cannot automatically adjust low-level cooking parameters such as spice intensity, cooking time, quantity, and dish category based on emotion-derived signals, which limits the ability of the system to converge toward user-satisfying outputs and increases the number of feedback cycles needed to reach acceptable proposals.

Fourth, typical architectures do not employ a feedback loop in which generated meal plans, user evaluations, and emotion evaluation information are transformed into feature quantities and used to update a learning model that controls future prompt sentences and parameter settings. Without this loop, the system cannot effectively evolve its proposal behavior at the system level. The absence of such dynamic adaptation results in repetitive or mismatched recommendations, inefficient use of database storage (because historical data are not exploited for model improvement), and additional processor cycles spent on generating options that the user is unlikely to select.

Fifth, product and service recommendation modules, when present, are often loosely coupled to the content-generation engine. Conventional systems typically map ingredient deficits to items in an online catalog without considering contextual ranking based on emotion and historical evaluation. This loose coupling prevents the system from efficiently determining an optimal presentation order for merchandise and services and requires extra client-server exchanges as the user manually navigates poorly ranked options.

Accordingly, there is a need for an improved computer-implemented system and method that: (i) aggregates inventory information, preference information, intake restriction information, selection history, and evaluation information into structured context information; (ii) constructs precise natural-language prompt sentences for a generative AI model based on that context; (iii) integrates multimodal emotion analysis into the adjustment of cooking parameters and into the construction of prompts; (iv) updates a learning model using feature quantities derived from generation results, evaluations, and emotion evaluation information to automatically evolve future proposals; and (v) efficiently determines and presents ranked merchandise and service information in coordination with generated meal plans, thereby improving the overall performance, responsiveness, and resource utilization of the computing system.

The specific processing by the specific processing unit 290 of the data processing device 12 in Application Example 2 is realized by the following means.

The present invention provides a server comprising a processor configured to receive, via a group communication function of an information communication application, input information including remaining information in a storage apparatus and preference information and intake restriction information for multiple participants; to convert the input information into structured data and store the structured data as history information in a storage unit; to generate context information by aggregating the history information including inventory information, the preference information, the intake restriction information, past selection history information, and evaluation information; to construct, from the context information, a prompt sentence that describes the context information in a natural language and to supply the prompt sentence as an input sentence to a generative AI model; to transmit the prompt sentence to the generative AI model and obtain, from the generative AI model, generation results including meal plan information and cooking procedure information; to acquire expression information, voice information, and text information of a user and to generate emotion evaluation information by using an emotion analysis unit that estimates an emotional state of the user; to adjust cooking parameters including spice intensity, cooking time, quantity, and dish category based on the generation results and the emotion evaluation information so as to optimize the meal plan information and the cooking procedure information; to determine shortage ingredient information based on the generation results and the inventory information, to obtain merchandise information via a communication interface of a merchandise providing system, and to automatically generate order information for an online ordering system and provide articles through a delivery service based on purchase candidate information; to extract ancillary service information including food-related services and movement-related services based on the generation results, the preference information, the intake restriction information, and the emotion evaluation information and to present the ancillary service information to the user; and to extract feature quantities from the generation results, the evaluation information, and the emotion evaluation information and to update a learning model that performs machine learning processing, thereby automatically adjusting, in subsequent processing, the prompt sentence and the cooking parameters used for controlling the generative AI model. This enables a computer system to more efficiently control a generative AI model through dynamically constructed prompt sentences, to integrate multimodal emotion analysis into low-level parameter adjustment, to reduce redundant computation and communication by generating proposals that better match user context, and to continuously evolve recommendation behavior through machine-learned updates, thereby improving the technical performance and resource utilization of the underlying information processing apparatus.

The term “information communication application” refers to a software platform executed on an information processing device and configured to transmit and receive digital information, including at least text, image, audio, or video data, between multiple users via a communication network.

The term “group communication function” refers to a function of an information communication application that enables a plurality of users to participate in a shared communication space and to exchange messages or information with each other in a collective manner.

The term “storage apparatus” refers to a physical apparatus configured to store articles, including at least foodstuffs or household items, under predetermined environmental conditions such as temperature or humidity.

The term “remaining information” refers to information indicating at least a type and an amount of articles currently stored in the storage apparatus.

The term “preference information” refers to information indicating at least a user's or participant's likes, dislikes, or priorities with respect to food, ingredients, cooking styles, cuisines, or related characteristics.

The term “intake restriction information” refers to information indicating at least a constraint or limitation on consumption of specific food components, ingredients, or nutrients, the constraint being based on health conditions, religion, lifestyle, or user choice.

The term “participant” refers to an individual or entity that uses the information communication application, provides preference information or intake restriction information, and receives proposed meal plan information or cooking procedure information.

The term “structured data” refers to data represented in a predetermined format having defined fields or attributes, such as records, tables, or objects, suitable for storage and retrieval in a storage unit by a computer program.

The term “history information” refers to accumulated structured data including at least past inventory information, preference information, intake restriction information, selection history information, evaluation information, or combinations thereof.

The term “inventory information” refers to information indicating at least a list, quantity, or state of articles stored in one or more storage apparatuses at a given time.

The term “selection history information” refers to information indicating at least past selections, acceptances, or uses of proposed meal plans, recipes, or related items by a user or participant.

The term “evaluation information” refers to information indicating at least an assessment, rating, or feedback provided by a user or participant regarding generated meal plans, cooking procedures, articles, or services.

The term “context information” refers to information generated by aggregating a plurality of kinds of history information, including inventory information, preference information, intake restriction information, selection history information, evaluation information, and optionally emotion evaluation information, and used to control behavior of a generative AI model.

The term “prompt sentence” refers to a text string written in a natural language that encodes context information and instructs a generative AI model to generate a response, the text string being constructed by the server.

The term “input sentence” refers to the prompt sentence or other natural-language text provided as input data to a generative AI model for use in a generation process.

The term “generative AI model” refers to a data processing model implemented by computer hardware and software and configured to generate at least natural-language text based on an input sentence, the model employing machine-learned parameters obtained by training with example data.

The term “meal plan information” refers to information describing at least a set of meals, dishes, or menus to be prepared or consumed over a period, and optionally including scheduling, nutritional balance, or serving size.

The term “cooking procedure information” refers to information describing at least a sequence of operations, steps, or instructions for preparing one or more dishes using specified ingredients and tools.

The term “generation result” refers to output information generated by the generative AI model in response to a prompt sentence, including at least meal plan information, cooking procedure information, or associated textual content.

The term “expression information” refers to information representing at least facial expressions or visual characteristics of a user captured by an image capturing device and used for emotion analysis.

The term “voice information” refers to information representing at least audio signals of speech or vocal sounds of a user captured by a sound capturing device and used for emotion analysis.

The term “text information” refers to information representing at least character-based content input or transmitted by a user via an information communication application, including messages, comments, or feedback.

The term “emotion analysis unit” refers to a hardware or software component configured to analyze expression information, voice information, text information, or a combination thereof and to estimate an emotional state of a user.

The term “emotional state” refers to a psychological condition of a user, such as joy, sadness, fatigue, satisfaction, dissatisfaction, or similar states, as determined by the emotion analysis unit.

The term “emotion evaluation information” refers to information output by the emotion analysis unit and indicating at least a type and optionally an intensity of the user's emotional state.

The term “cooking parameters” refers to numeric or categorical control values related to cooking, including at least spice intensity, cooking time, quantity, and dish category.

The term “spice intensity” refers to a value indicating a relative strength of pungent or strongly flavored ingredients in a dish.

The term “cooking time” refers to a value indicating at least a duration required to perform one or more cooking procedures.

The term “quantity” refers to a value indicating an amount, volume, or weight of ingredients or prepared dishes.

The term “dish category” refers to a classification label indicating a type or role of a dish, including at least main dish, side dish, dessert, beverage, or cuisine style.

The term “shortage ingredient information” refers to information indicating at least ingredients required by generated meal plan information or cooking procedure information but not sufficiently present in the inventory information.

The term “merchandise providing system” refers to an external or internal information processing system configured to provide merchandise information and to accept order information via a communication interface.

The term “communication interface” refers to a hardware or software interface configured to exchange data between the server and another system, including at least an application programming interface accessible via a communication network.

The term “merchandise information” refers to information describing articles available for purchase, including at least product identifiers, names, prices, quantities, and delivery options.

The term “candidate merchandise” refers to a subset of merchandise information selected as suitable to satisfy the shortage ingredient information or related requirements.

The term “purchase candidate information” refers to information generated by selecting one or more candidate merchandise items that may be purchased to fulfill needs indicated by the generation result and the inventory information.

The term “online ordering system” refers to an information processing system accessible via a network and configured to receive order information, process purchases, and manage delivery of articles.

The term “order information” refers to information transmitted to an online ordering system that indicates at least items to be purchased, quantities, delivery address, and payment-related data.

The term “delivery service” refers to a service provider or mechanism that transports physical articles from a distribution facility to a user based on order information.

The term “ancillary service information” refers to information indicating services related to food or movement, including at least ingredient delivery services, cooking lesson services, or travel-related services.

The term “food-related service” refers to a service associated with food or cooking, including at least meal delivery, ingredient subscription, cooking instruction, or dining reservations.

The term “movement-related service” refers to a service associated with physical movement or travel, including at least transportation, lodging, or travel package arrangements.

The term “related proposal information” refers to information presented to a user that includes ancillary service information associated with generated meal plan information or cooking procedure information.

The term “feature quantities” refers to numerical or categorical values extracted from generation results, evaluation information, and emotion evaluation information and used as input variables for a learning model.

The term “learning model” refers to a machine-learning-based data processing model configured to update internal parameters based on feature quantities and to output control values used to adjust prompt sentences or cooking parameters.

The term “machine learning processing” refers to a computational process in which a learning model updates internal parameters using training data comprising feature quantities and associated target values.

The term “ranking process” refers to a process that orders or scores merchandise information or service information based on one or more criteria, such as evaluation information or emotion evaluation information.

The term “merchandise information and service information related to the meal plan information and the cooking procedure information” refers to information about articles and services that support or supplement the preparation, consumption, or enjoyment of dishes specified by the meal plan information and cooking procedure information.

The term “additional proposal information” refers to information that suggests additional articles or services beyond the primary meal plan or recipe, including at least ancillary service information, promotional offers, or related products.

The term “daily contact” refers to repeated and continuous interactions between a user and the system or among participants via the information communication application on a daily or near-daily basis.

The term “information processing apparatus” refers to a hardware device or a combination of devices including at least a processor and a memory, configured to execute instructions for data processing.

The term “processor” refers to a hardware component, such as a central processing unit or a dedicated processing circuit, configured to execute instructions that implement the functions described in the system.

In one embodiment, a server, a plurality of terminals, and at least one storage apparatus cooperate to implement the claimed system. The server includes at least one processor, a main memory, a nonvolatile storage unit, and a network interface. The terminals include communication circuitry, a display, an input interface, a camera, and a microphone. The storage apparatus includes physical storage for articles such as foodstuffs and may further include sensors for internal status.

The server, the terminals, and the storage apparatus are interconnected via a communication network such as the Internet.

### A. Overall Software Architecture

The server executes a plurality of software modules implemented, for example, in a high-level programming language executed on an operating system. In one example, the server executes an application server framework and stores data in a database management system. The server further uses a machine-learning framework, such as a tensor-based numerical computation library, to implement learning models. The server communicates with an external generative AI model via an application programming interface and with one or more external merchandise providing systems and online ordering systems via respective communication interfaces.

The terminal executes an information communication application providing a group communication function. In one embodiment, the information communication application is a chat or messaging application that supports group conversations, user authentication, and media transmission. The terminal uses an operating system service to access the camera and the microphone and to obtain expression information and voice information.

### B. Data Structures and Storage

The server stores user and participant data as structured data in a storage unit. The server represents inventory information as records each including at least an article identifier, an article name, a quantity, a unit, a storage location identifier, and a timestamp. The server represents preference information and intake restriction information as profile records including categorical attributes such as preferred cuisine type, disliked ingredients, target calorie range, and boolean fields indicating restrictions such as gluten free, dairy free, or vegetarian. The server represents selection history information as records linking a generated menu identifier with a timestamp and a selection flag. The server represents evaluation information as records including a rating score, a free-text comment, and associations with a specific generated meal plan.

The server represents emotion evaluation information as records including an emotion label (for example, joy, fatigue, dissatisfaction) and a numeric confidence score, together with references to the corresponding expression information, voice information, or text information. The server stores these data in relational tables or document-based collections and maintains indexes to enable efficient retrieval of data relevant to a particular user or group of participants.

### C. Context Generation and Prompt Sentence Construction

The server aggregates inventory information, preference information, intake restriction information, selection history information, and evaluation information into context information. The server implements a context generation module that reads the structured data, applies normalization procedures, and aggregates the data into a context object. The server uses, for example, a text-processing library to normalize ingredient names, to reduce synonyms, and to identify key phrases in evaluation comments such as “too spicy”, “too salty”, or “too much work”.

The server converts the aggregated context information into a prompt sentence for a generative AI model. The server implements a prompt construction module that maps structured attributes into natural-language clauses according to a predetermined template. For example, the server generates a prompt sentence such as:

“The refrigerator contains: eggs (2), milk (1 liter), and tomatoes (3). The user prefers low-calorie meals and cannot eat gluten. The user is currently tired. The user previously said: ‘The spicy chicken curry was too spicy.’ Based on this information, propose a simple dinner menu for tonight that is mild in spiciness, low in calories, gluten-free, and can be cooked in less than 20 minutes. Provide a recipe with step-by-step instructions.”

The server may construct other prompt sentences. In another example, the server generates:

“The user likes Italian cuisine. Please propose an Italian dinner menu plan for this week, using typical Italian ingredients. Also suggest related ingredients that can be delivered and services such as cooking lessons or travel packages related to Italian cuisine.”

In another example, the server generates:

“The refrigerator contains: chicken breast (300 g), broccoli (1 head), carrots (2), and rice (200 g). The user prefers healthy, low-fat meals and is currently tired, according to emotion analysis. The user previously said: ‘The spicy chicken curry was too spicy.’ Please propose a mild and comforting dinner recipe that can be prepared in under 25 minutes, using only the available ingredients if possible. Provide a clear title, a list of ingredients with quantities, and numbered step-by-step cooking instructions.”

By encoding structured context information in a single, coherent prompt sentence, the server reduces ambiguity, avoids repeated API calls, and improves the precision of outputs from the generative AI model, thereby improving processing efficiency and reducing communication load.

### D. Generative AI Model Interaction and Internal Processing

The server transmits the prompt sentence to a generative AI model. In one embodiment, the generative AI model is a transformer-based neural network trained on large-scale text data. The generative AI model includes multiple layers of self-attention blocks and feed-forward neural networks. Each layer receives an input representation of the prompt sentence as token embeddings and positional embeddings, computes self-attention weights, and outputs refined embeddings. The model includes billions of parameters stored in a numeric tensor representation and updated during a prior training process.

The server supplies the prompt sentence as the input sentence to the generative AI model and receives, from the generative AI model, a sequence of output tokens. The server concatenates the output tokens into an output text that includes meal plan information and cooking procedure information. The server subsequently parses the output text to identify sections such as a recipe title, ingredient list, and step-by-step instructions, by detecting headings or keywords such as “Ingredients:” and “Steps:”.

Because the server constructs a context-rich prompt sentence, the generative AI model is guided to produce outputs that are more consistent with the actual inventory information and constraints, thereby decreasing occurrences of impossible or irrelevant recipes. This controlled prompting improves the computational efficiency of the generative AI model invocation, because fewer post-processing corrections and fewer repeated calls are required.

### E. Emotion Analysis and Cooking Parameter Adjustment

The terminal captures expression information via the camera and voice information via the microphone while the user interacts with the system. The terminal transmits the captured media and associated text information to the server. The server executes an emotion analysis unit that analyzes the expression information, the voice information, and the text information. In one embodiment, the emotion analysis unit includes a convolutional neural network to classify facial expressions and a recurrent neural network or transformer model to classify sentiment from text and speech features. The emotion analysis unit uses a predefined loss function such as cross-entropy to learn emotion labels and uses gradient-based weight updates during training.

The server converts the outputs of the emotion analysis unit into emotion evaluation information including an emotion label and a confidence score. The server maps the emotion evaluation information to adjustments of cooking parameters. For example, when the emotion analysis unit detects fatigue with high confidence, the server reduces a target cooking time parameter and increases a simplicity parameter. When the emotion analysis unit detects dissatisfaction after a previous recipe was executed, and when the evaluation information includes text such as “too spicy”, the server reduces a target spice intensity parameter.

The server uses a cooking parameter adjustment module to transform these signals into numeric ranges or categorical constraints. The server then uses the adjusted cooking parameters when constructing the prompt sentence and when modifying the generation results. For example, the server ensures that the prompt sentence contains explicit instructions such as “mild in spiciness” and “can be cooked in less than 20 minutes”. This fine-grained, parameterized adjustment reduces the likelihood of outputs that conflict with the user's current emotional state, thereby improving the accuracy of recommendations and reducing the need for manual corrections.

### F. Learning Model and Technical Improvement

The server extracts feature quantities from the generation results, the evaluation information, and the emotion evaluation information. The server represents each interaction as a feature vector that may include features such as cuisine type, estimated cooking time, ingredient novelty, user rating, emotion label before execution, emotion label after execution, and whether the recipe was accepted or rejected. The server uses these feature quantities as input to a learning model implemented in a machine-learning framework.

In one embodiment, the learning model is a feed-forward neural network with one or more hidden layers. The server defines an objective function such as mean-squared error between predicted satisfaction scores and actual user ratings. The server updates model weights by applying a stochastic gradient-descent algorithm with backpropagation. The server may also apply data augmentation, such as random noise injection or oversampling of rare emotion combinations, to improve generalization.

The server uses the output of the learning model to compute control values, such as a predicted satisfaction score for a candidate set of cooking parameters. The server uses these control values when generating context information and constructing a prompt sentence. For example, the server increases the weight of constraints that historically correlate with high satisfaction for a particular user. This feedback loop enables the server to evolve its proposal behavior over time and to reduce unnecessary model invocations that would produce low-quality proposals.

Because the server uses an internal learning model to control prompt sentences and cooking parameters, the system improves computing efficiency by pre-filtering unlikely configurations before invoking the generative AI model. This reduces computation at the generative AI model layer, decreases network traffic, and shortens response times. The improvement is not merely a human task automation but a technical enhancement to how computer systems manage model invocation, parameter selection, and data reuse.

### G. Merchandise Selection and Ranking

The server determines shortage ingredient information by comparing the ingredient list output by the generative AI model with the inventory information. The server generates a list of required ingredients and their required quantities. The server then queries a merchandise providing system via a communication interface. The server sends a structured request including the shortage ingredient information and possibly user preference attributes (for example, preference for organic options).

The server receives merchandise information from the merchandise providing system and selects candidate merchandise. The server performs a selection algorithm that considers price, package size, brand category, and compatibility with intake restriction information. The server further performs a ranking process that orders merchandise and service information based on evaluation information and emotion evaluation information. For instance, the server increases ranking scores for products that historically received positive evaluations under similar emotional states.

The server presents the ranked merchandise information and ancillary service information as related proposal information to the user. By integrating ranking based on learned feature quantities, the server reduces user interaction steps needed to reach desirable items and decreases unnecessary client-server interactions, thereby reducing communication load.

### H. Terminals and User Interaction

The user operates a terminal to launch the information communication application and access the group communication function. The user inputs remaining information in the storage apparatus, preference information, and intake restriction information through a graphical user interface. The terminal transmits the input data to the server as structured messages.

The terminal receives generated meal plan information, cooking procedure information, and related proposal information from the server. The terminal displays recipes as structured screens including titles, ingredient lists, and step-by-step instructions. The terminal further displays purchase buttons for merchandise and service recommendations. When the user selects items for purchase, the terminal sends corresponding selection information to the server.

Because the terminal and the server cooperate using structured data flows and prompt-controlled generative AI outputs, the number of redundant user interactions is reduced. The terminal does not need to repeatedly request alternative menus, because the initial proposals are more likely to satisfy constraints. This reduces network bandwidth consumption and local processing.

### I. Alternative Embodiments and Variations

The server may implement different generative AI models. In one variant, the generative AI model is hosted on the same physical server as the application logic. In another variant, the generative AI model resides on a separate computing system accessible over a network. The server may use different neural network architectures, such as encoder-decoder models or recurrent neural networks, provided that a prompt sentence can be supplied and a natural-language output can be generated.

The server may implement different emotion analysis units. In one embodiment, the emotion analysis unit uses only text information and a sentiment classifier. In another embodiment, the emotion analysis unit uses multimodal fusion of expression information, voice information, and text information via an attention-based fusion network. The server may adjust which modalities are used depending on terminal capabilities and user privacy settings.

The server may also use different learning models for controlling prompt sentences and cooking parameters. For example, the server may use a gradient-boosted decision tree model instead of a neural network, or may use a reinforcement-learning approach where rewards are derived from long-term user satisfaction metrics.

The server may implement different storage schemes. In one variant, the server stores all history information in a relational database. In another variant, the server stores context snapshots in a document datastore to speed up retrieval for prompt construction. The server may further cache frequently used context information in a high-speed memory store to accelerate prompt generation.

### J. Technical Effects

By structuring and aggregating inventory information, preference information, intake restriction information, selection history information, evaluation information, and emotion evaluation information into context information, and by constructing prompt sentences accordingly, the server improves the way a computing system controls a generative AI model. This avoids naive, stateless invocation of the model and reduces the number of calls and corrections needed.

By integrating multimodal emotion analysis into cooking parameter adjustment and learning model updates, the server transforms otherwise qualitative feedback into structured numerical signals that directly influence internal data processing. This results in more accurate proposals and fewer failed recommendations, thereby reducing overall computation and network usage.

By updating a learning model that in turn governs prompt sentence content and low-level parameters, the server creates a closed-loop control mechanism that continuously optimizes model usage. This goes beyond mere automation of human decision-making and provides a concrete technical improvement in model control, data management, and computation scheduling within the computer system.

Accordingly, the server, the terminals, and the storage apparatus collectively implement the claimed system in a way that can be realized in practice, that improves processing speed, accuracy, and resource utilization, and that provides a concrete technical application of a generative AI model controlled via context-dependent prompt sentences.

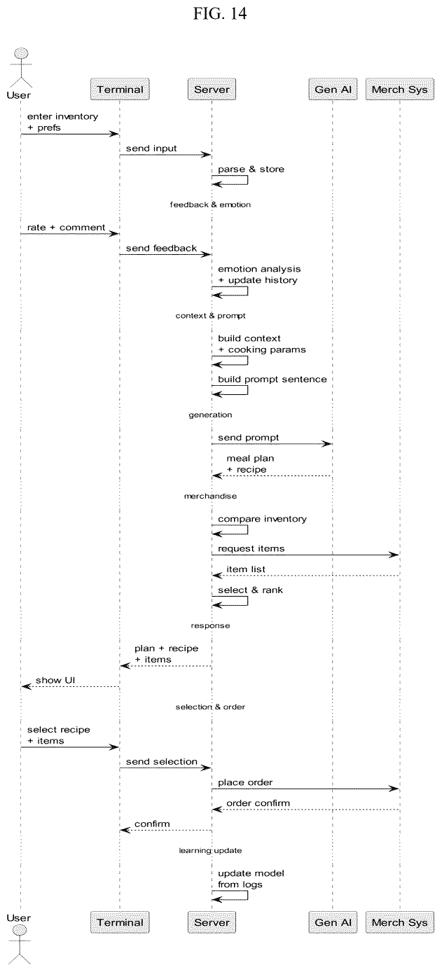

The following describes the processing flow using FIG. 14.

### Step 1:

User operates the terminal to input basic information.

User launches an information communication application on the terminal and opens a group communication function. User inputs remaining information of a storage apparatus (for example, “eggs 2, milk 1 L, tomatoes 3”) and personal or family preference information and intake restriction information (for example, “low-calorie preferred, no gluten, likes Italian food”).

Input: raw text or form data entered by the user via the terminal UI.

Output: structured message data (for example, a JSON-like object) containing inventory fields, preference fields, and restriction fields. The terminal performs data formatting (string tokenization, key-value assignment) and attaches user identifiers and timestamps before sending the structured message to the server.

### Step 2:

Terminal transmits user input to the server.

Terminal sends the structured message through a network interface using a secure protocol. The terminal may compress the payload and add authentication tokens.

Input: structured message generated in Step 1, plus session/authentication data.

Output: network packets containing the structured message delivered to the server. The terminal executes communication operations (packet creation, encryption, transmission) but does not alter the content payload.

### Step 3:

Server parses and normalizes the received data.

Server receives the structured message, validates authentication, and parses inventory, preferences, and restrictions. Server applies normalization rules to ingredient names (for example, converting variants like “Tomatoes”, “tomato” into a canonical term “tomato”), converts units into standard units, and maps free-text diet statements into internal flags.

Input: structured message from the terminal.

Output: normalized structured records for inventory information, preference information, and intake restriction information. The server performs data processing including string normalization, unit conversion, and category mapping.

### Step 4:

Server stores structured data as history information.

Server writes the normalized records into a storage unit such as a database. Server assigns record identifiers and links the new records to the corresponding user or group.

Input: normalized records from Step 3.

Output: persistent history information stored in database tables or collections, together with indices for later retrieval. The server performs data insertion operations and updates indices to support efficient queries.

User provides feedback and emotional context.

User reviews previously proposed meal plan information and cooking procedure information displayed on the terminal. User inputs evaluation information such as ratings (for example, 4 out of 5) and comments (for example, “too spicy”, “easy to cook”). User optionally allows the terminal to use the camera and microphone while giving feedback.

Input: user rating, text comment, and consent state for media capture.

Output: a feedback message generated by the terminal containing evaluation information and pointers to captured media.

### Step 6:

Terminal captures expression information and voice information and sends them with feedback.

Terminal activates the camera and microphone, captures a short sequence of image frames and audio samples while the user provides feedback, and associates timestamps with these media data.

Terminal compresses the media data, tags them with the feedback record ID, and transmits them to the server along with text feedback.

Input: raw sensor data from the camera and microphone, plus text feedback.

Output: compressed media data (images/audio) and formatted feedback payload delivered to the server. The terminal performs media acquisition, encoding, and packetization.

### Step 7:

Server performs emotion analysis.

Server receives the feedback payload and media data. Server passes the text portion through a text sentiment classifier and passes image frames through a facial expression classifier and optionally passes audio features through a voice emotion classifier. Server then fuses outputs from these classifiers to estimate an emotional state.

Input: text comment, compressed image frames, compressed audio samples.

Output: emotion evaluation information containing an emotion label (for example, “tired”, “joyful”, “dissatisfied”) and a confidence score. The server performs data decoding, feature extraction, classification using neural networks, and fusion (for example, weighted averaging of probabilities).

### Step 8:

Server updates evaluation and emotion records.

Server links the evaluation information and emotion evaluation information with the corresponding generated menu and recipe identifiers and stores them in the history.

Input: evaluation information from feedback, emotion evaluation information from Step 7.

Output: updated history records including evaluation fields and emotion fields associated with past generation results. The server performs database update operations and ensures referential integrity.

### Step 9:

Server retrieves relevant history to generate context information.

Server queries the database to retrieve, for the current user or group, the latest inventory information, stored preference information, intake restriction information, recent selection history, and recent evaluation and emotion records. Server aggregates these records into a context object that summarizes the current state and recent behavior.

Input: user or group identifier and history information stored in the database.

Output: context information containing structured fields such as ingredient list, dietary flags, preferred cuisines, typical preparation times, and patterns detected from recent evaluations. The server performs data retrieval, joining, and aggregation operations.

### Step 10:

Server calculates cooking parameters using a learning model.

Server uses feature quantities derived from past interactions (for example, “too spicy” comments, fatigue labels, acceptance rates) as input to a learning model implemented using a machine-learning framework. Server feeds the context object into the learning model, which outputs recommended ranges for cooking parameters such as target spice intensity, target cooking time, and preferred portion size.

Input: context information from Step 9 and feature quantities from stored interactions.

Output: a set of cooking parameters expressed as numeric values or categorical labels. The server performs numerical computations, model inference (matrix multiplications, activation functions), and parameter mapping.

### Step 11:

Server constructs a context-rich prompt sentence.

Server combines the context information and the cooking parameters into a natural-language prompt sentence according to a template. Server inserts inventory details, preferences, restrictions, emotional state, and explicit parameter constraints into the text.

Input: context information and cooking parameters from Step 10.

Output: a prompt sentence suitable as an input sentence for a generative AI model. The server performs text composition, template filling, and string formatting to create a coherent instruction.

### Step 12:

Server sends the prompt sentence to the generative AI model and obtains generation results.

Server constructs an API request that includes the prompt sentence, model identifier, and inference parameters, and sends it to the generative AI model. After receiving the response, server concatenates output tokens into text and parses it into structured components such as meal plan information and cooking procedure information.

Input: prompt sentence from Step 11.

Output: generation results consisting of structured meal plan information and cooking procedure information. The server performs network communication, output token handling, text reconstruction, and rule-based parsing.

### Step 13:

Server checks inventory and determines shortage ingredient information.

Server compares the ingredient list in the generation results with the inventory information available in the context. For each required ingredient, server calculates the difference between required quantity and current quantity. If the difference is positive, server records that ingredient and required amount as shortage ingredient information.

Input: ingredient list from the generation results and inventory information from the context.

Output: shortage ingredient information indicating items that must be procured. The server performs set comparison and arithmetic subtraction.

### Step 14:

Server retrieves merchandise information and selects candidate merchandise.

Server sends a query containing the shortage ingredient information to a merchandise providing system via a communication interface. Server receives merchandise information including product IDs, prices, package sizes, and attribute tags. Server filters merchandise based on intake restriction information and preference information and selects candidate merchandise that satisfy quantity and constraint requirements.

Input: shortage ingredient information and preference/intake restriction information.

Output: purchase candidate information listing candidate merchandise items for each shortage ingredient. The server performs external API requests, filtering operations, constraint checking, and selection logic.

### Step 15:

Server ranks merchandise and ancillary service information.

Server takes purchase candidate information and ancillary service information (for example, cooking lessons, travel-related services) and uses evaluation information and emotion evaluation information to assign ranking scores. Server may use a ranking model that takes features such as price, past acceptance, and emotion compatibility as input and outputs a score for each item.

Input: purchase candidate information, ancillary service information, evaluation and emotion evaluation information.

Output: ranked lists of merchandise information and service information, with high-scoring items at the top. The server performs feature extraction, ranking model inference, and sorting operations.

### Step 16:

Server prepares a combined response for the terminal.

Server packages the meal plan information, cooking procedure information, ranked merchandise information, and ancillary service information into a response payload. Server structures the payload so that the terminal can easily render sections such as “menu”, “recipe steps”, “ingredients to order”, and “related services”.

Input: generation results from Step 12, purchase candidate information from Step 14, ranked results from Step 15.

Output: a structured response payload ready for presentation on the terminal. The server performs data aggregation and formatting.

### Step 17:

Terminal receives and displays proposals.

Terminal decodes the response payload, generates user-interface elements, and displays the meal plan information and cooking procedure information on the display. Terminal also presents interactive controls for ordering missing ingredients and for selecting ancillary services.

Input: response payload from the server.

Output: rendered screens showing recipes, ingredient lists, and options for merchandise and services.

The terminal performs UI layout, text rendering, and event binding.

### Step 18:

User selects menus, ingredients, and services.

User reviews the displayed content, chooses a recipe or a set of menus to execute, and optionally selects items to order and services to use. User interacts with buttons or other UI elements to confirm selections.

Input: visual presentation on the terminal and interactive widgets.

Output: selection commands from the user, which the terminal converts into selection data containing identifiers of recipes, merchandise, and services.

### Step 19:

Terminal sends selection data to the server.

Terminal transmits the selection data to the server through the communication network. The selection data include user identifiers, selected menu IDs, selected merchandise IDs, and selected service IDs, as well as quantities where applicable.

Input: user selections collected in Step 18.

Output: request messages to the server indicating desired orders and bookings. The terminal performs message assembly and network transmission.

### Step 20:

Server generates order information and communicates with external systems.

Server receives the selection data and creates order information conforming to the format required by each online ordering system and service provider. Server sends order requests, receives confirmations, and records order identifiers and delivery schedules.

Input: selection data from Step 19 and purchase candidate information from Step 14.

Output: confirmed order information and booking information stored in the server and later returned to the terminal. The server performs data transformation, external API communication, and transaction logging.

### Step 21:

Server updates the learning model with new interaction data.

Server constructs new feature quantities based on which recipes were selected, which merchandise and services were purchased, the associated evaluation information, and post-interaction emotion evaluation information. Server appends these feature vectors and target labels (for example, satisfaction ratings) to the training dataset and periodically retrains or fine-tunes the learning model.

Input: interaction logs, evaluation information, and emotion evaluation information.

Output: updated learning model parameters that will influence future cooking parameter predictions and prompt sentence construction. The server performs data batching, loss computation, gradient calculation, and parameter updates.

### Step 22:

Server adjusts future prompt sentence and parameter generation based on updated model.

Server uses the updated learning model in subsequent cycles to compute new cooking parameters and to weigh different constraints when constructing prompt sentences. Over time, the server produces context information and prompt sentences that more accurately reflect user behavior and emotional responses.

Input: updated model parameters from Step 21 and future context information.

Output: refined cooking parameters and improved prompt sentences for subsequent calls to the generative AI model. The server performs inference with the new model and modifies its prompt construction logic accordingly.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

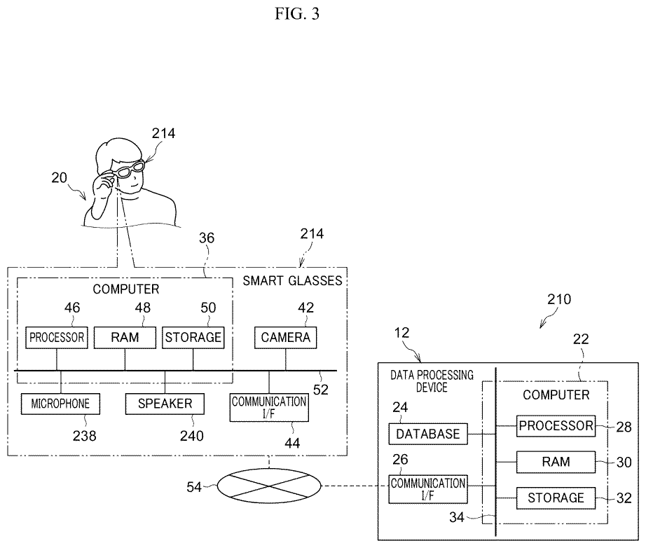

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein.

The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

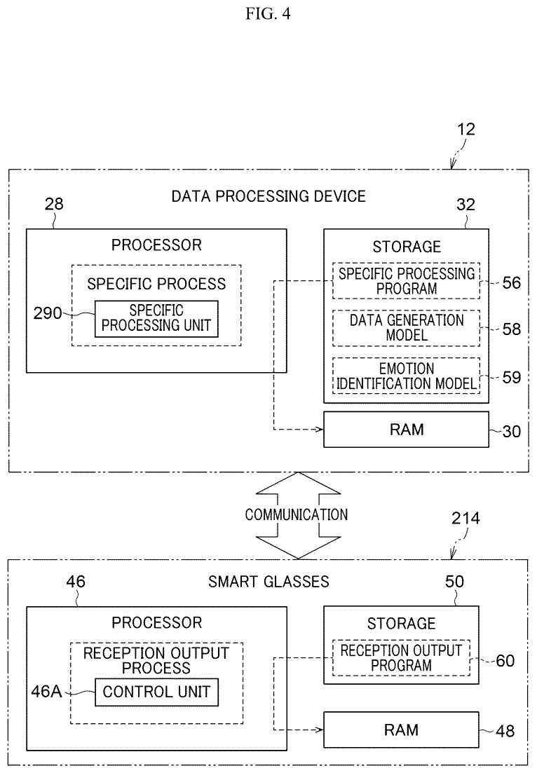

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user.

Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

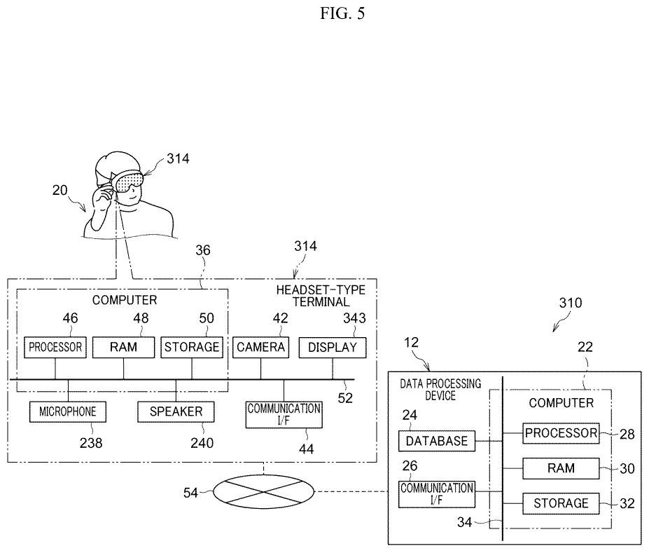

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

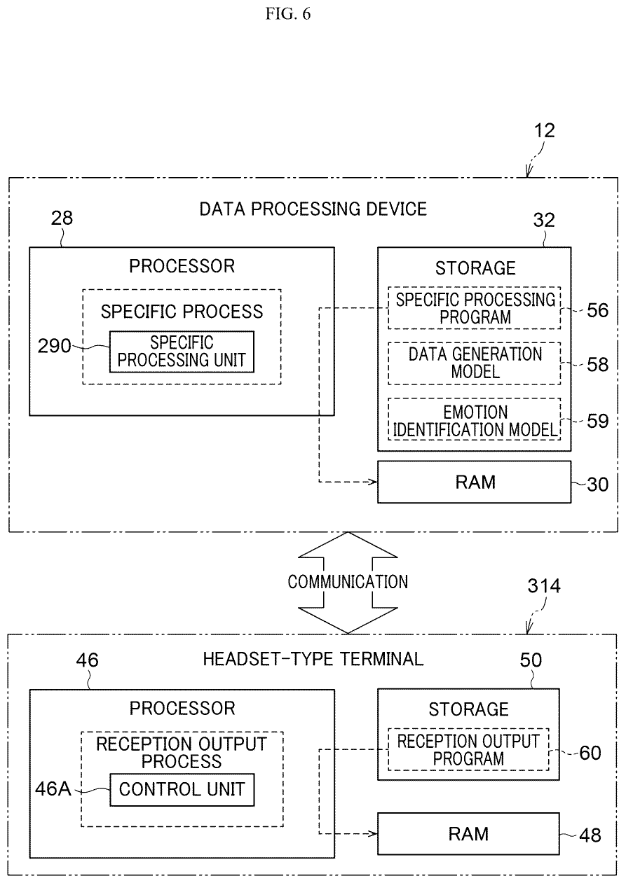

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

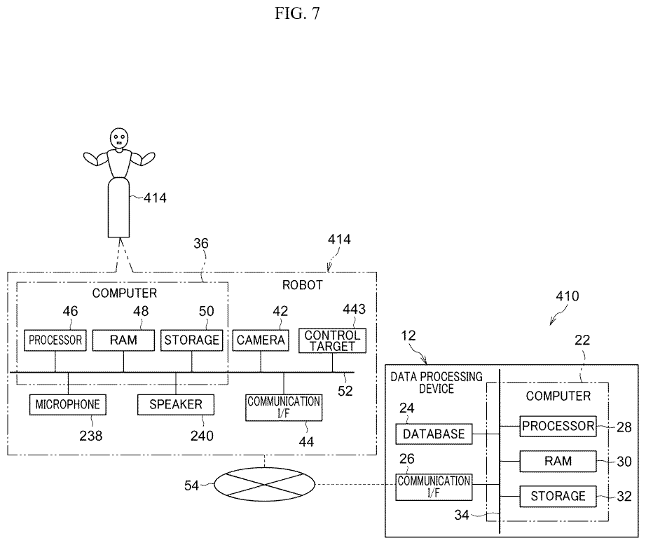

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

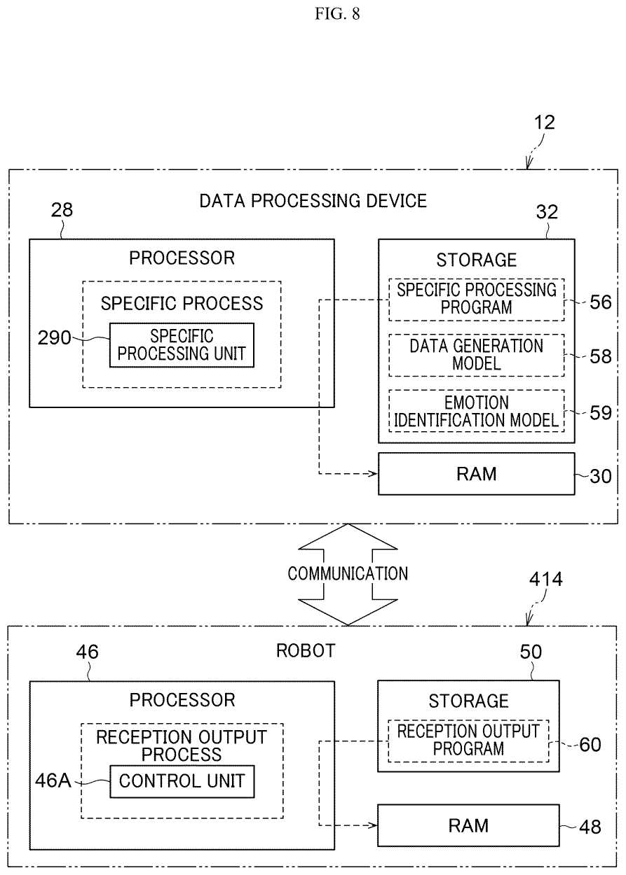

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

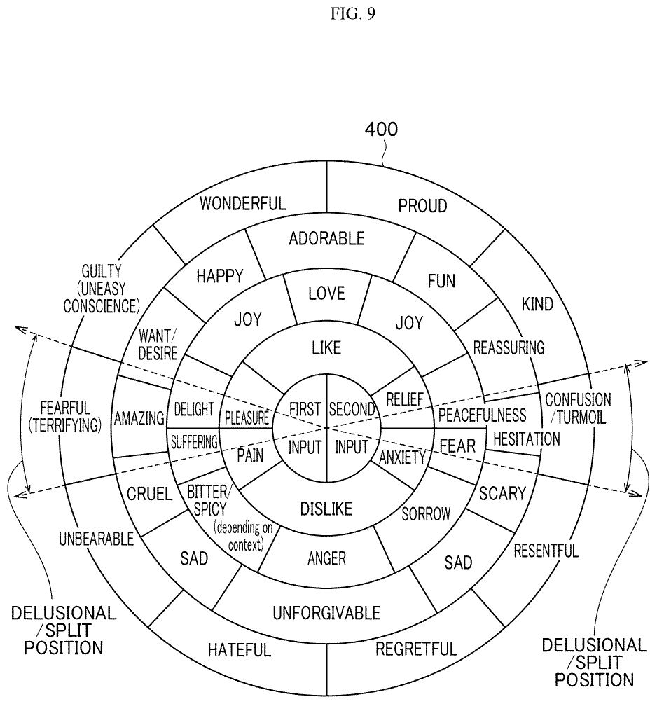

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

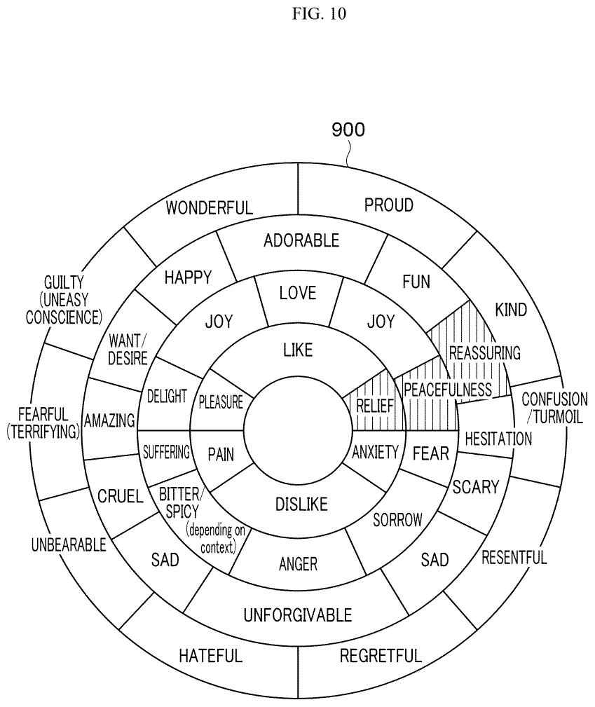

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a memory,
wherein the processor is configured to
acquire, via a message-processing application executed on a terminal, text information that a user inputs in a group communication screen regarding food stored in a storage apparatus, receive the text information via a communication control device, extract food item candidates from the text information, normalize the food item candidates into identifier information representing generalized item categories, and store the identifier information in an item-information storage region of the memory,
convert, by natural-language analysis processing, preference information and intake-restriction information of participants acquired via the message-processing application into structured attribute information, and store the attribute information in a preference-information storage region of the memory,
create a prompt sentence, based on food item information obtained from the item-information storage region and attribute information obtained from the preference-information storage region, for causing a generative AI model to generate a cooking-plan candidate and a cooking-procedure candidate, input the prompt sentence into the generative AI model, and obtain a generation result including the cooking-plan candidate and the cooking-procedure candidate from the generative AI model, format the generation result into a text format adapted to an interface specification of the message-processing application, and transmit the formatted text to the group communication screen via the communication control device so that the generation result is shared among the participants, compare food items required for the cooking-plan candidate and the cooking-procedure candidate with the food item information stored in the item-information storage region, identify missing components, transmit order information for the missing components to an online transaction processing system, and cause a distribution processing means to provide the missing components to the user, and
update the food information and the preference information stored in the respective storage regions in response to additional inputs from the user, reconfigure the prompt sentence supplied to the generative AI model in accordance with the updated contents, and repeatedly propose updated cooking-plan candidates and updated cooking-procedure candidates.

### (Supplementary 2)

The system according to supplementary 1,
wherein the processor is configured to acquire, via the message-processing application, evaluation information and comment information from the participants regarding the cooking-plan candidate and the cooking-procedure candidate, incorporate the evaluation information and the comment information into the prompt sentence as additional input to the generative AI model, and thereby adaptively change contents of cooking-plan candidates and cooking-procedure candidates generated in subsequent processing.

### (Supplementary 3)

The system according to supplementary 1,
wherein the processor is configured to analyze dialogue-history information based on the cooking-plan candidates and the cooking-procedure candidates presented in the group communication screen, extract interest-area information from the dialogue-history information, automatically generate candidate information related to outside activities or leisure activities based on the interest-area information, and provide additional proposals regarding related services via the message-processing application so as to expand sales opportunities.

### Application Example 1

### (Supplementary 1)

A system comprising a processor,
wherein the processor is configured to
control, in a multi-user conversation screen of a communication application operating on a terminal device having a communication function, input by a user of food information and beverage information stored in a cooling storage apparatus as character information or image information, and sharing of the food information and the beverage information with other participating users, acquire, from the terminal device, preference information and dietary restriction information for each participating user, and store the preference information and the dietary restriction information as structured data in a storage device in association with user identification information, receive, from the terminal device, the food information and the beverage information in the cooling storage apparatus, normalize the food information and the beverage information as inventory information including an item name and a quantity, and update and manage the inventory information on a per-user or per-household basis,
generate a prompt sentence for input to a generative AI model based on the inventory information, the preference information, and the dietary restriction information, transmit the prompt sentence to the generative AI model disposed externally or internally, and obtain response information including cooking proposal information and cooking procedure information from the generative AI model, analyze required ingredient information included in the cooking proposal information and the cooking procedure information, compare the required ingredient information with the inventory information to calculate shortage ingredient information, and identify product information corresponding to the shortage ingredient information from product management data,
generate, based on confirmation response information from the user, order information including the product information corresponding to the shortage ingredient information, and transmit the order information to an external merchandise delivery service information processing device so as to initiate automatic purchasing processing and delivery processing,
generate the cooking proposal information and the cooking procedure information as display information for the conversation screen of the communication application, and transmit the display information to the terminal device so as to enable menu selection and cooking assistance through interaction among the participating users, and
collect evaluation information and comment information transmitted from the participating users, and use the collected information as additional input information to the generative AI model so as to update, in a learning manner, generation logic of subsequent cooking proposal information and cooking procedure information.

### (Supplementary 2)

The system according to supplementary 1,
wherein the processor is configured to
execute character recognition processing or code recognition processing on the image information acquired via the communication application so as to automatically extract the food information and the beverage information, and subject the extracted food information and the beverage information to the normalization as the inventory information.

### (Supplementary 3)

The system according to supplementary 1,
wherein the processor is configured to
analyze, based on the cooking proposal information and the cooking procedure information, a nutritional intake tendency and a preference tendency for each participating user, and reflect an analysis result in the preference information and the dietary restriction information so as to optimize generation of the prompt sentence and the response information from the generative AI model.

### Example 2

### (Supplementary 1)

A system comprising a processor and a storage device,
wherein the processor is configured to
receive, via a communication network and a terminal executing an information communication application having a group conversation function, inventory information including types and quantities of food items stored in a storage apparatus, as text data from a user, and register the inventory information in the storage device in association with identification information, receive, via the group conversation function and the terminal, attribute information including preference information and intake restriction information from the user, store the attribute information in the storage device in association with the inventory information, and generate a preference profile for the user based on the attribute information,
generate a prompt sentence to be input to a generative AI model based on the inventory information and the preference profile stored in the storage device, and transmit inquiry data including the prompt sentence to the generative AI model via the communication network,
receive natural language text output from the generative AI model in response to the prompt sentence, extract meal plan information and cooking procedure information from the natural language text, store the meal plan information and the cooking procedure information as structured data in the storage device, and present the meal plan information and the cooking procedure information to the terminal via the group conversation function,
identify, based on at least one of the meal plan information and the cooking procedure information, one or more food items that are not included in the inventory information as shortage items, generate product information related to the shortage items, and request provision of the shortage items by transmitting the product information to a product providing system via the communication network, receive, via the terminal, feedback information including evaluation text regarding at least one of the meal plan information and the cooking procedure information from the user, and accumulate the feedback information in the storage device,
perform preprocessing on text data included in the feedback information accumulated in the storage device to generate preprocessed data, input the preprocessed data to the generative AI model as learning data, and update at least one of the generative AI model and prompt-sentence generation logic such that meal plan information and cooking procedure information subsequently generated by the generative AI model are adaptively evolved to match user preferences, and share the meal plan information and the cooking procedure information among a plurality of users participating in the group conversation function, and collect comments from the plurality of users on the shared information as additional feedback information.

### (Supplementary 2)

The system according to supplementary 1,
wherein the processor is configured to
extract, from the feedback information, evaluation expressions related to pungency or similar taste evaluations, update the preference profile to include a pungency tolerance parameter, and add the pungency tolerance parameter as a constraint condition to the prompt sentence, thereby automatically adjusting seasoning conditions in the meal plan information and the cooking procedure information generated by the generative AI model.

### (Supplementary 3)

The system according to supplementary 1,
wherein the processor is configured to
periodically distribute the meal plan information and the cooking procedure information to the terminal via the group conversation function so as to continuously generate contact opportunities among a plurality of users in a household, and present, together with the meal plan information, external service information or additional product information related to the meal plan information to guide the plurality of users to related services.

### Application Example 2

### (Supplementary 1)

A system comprising a processor,
wherein the processor is configured to
receive, via a group communication function of an information communication application, input information in which a user inputs remaining information in a storage apparatus and preference information and intake restriction information of participants, and to share the input information with other participants,
store inventory information, preference information, and intake restriction information included in the input information as structured data in a recording area of a storage unit, and accumulate the structured data as history information,
generate, based on the history information, context information in which the inventory information, the preference information, the intake restriction information, past selection history information, and evaluation information are aggregated, and construct an input sentence for a generative AI model by generating a prompt sentence that describes the context information in a natural language,
transmit the prompt sentence to an external or internal generative AI model, cause the generative AI model to generate, by natural language processing, meal plan information including period information and cooking procedure information, and acquire a generation result, acquire expression information, voice information, and text information of a user, generate emotion evaluation information by using an emotion analysis unit that estimates an emotional state of the user based on the expression information, the voice information, and the text information, and optimize the meal plan information and the cooking procedure information by adjusting cooking parameters including spice intensity, cooking time, quantity, and dish category based on the emotion evaluation information and the generation result,
extract shortage ingredient information based on the generation result and the inventory information, acquire merchandise information by using the shortage ingredient information via a communication interface of a merchandise providing system, select candidate merchandise from the acquired merchandise information to generate purchase candidate information, and perform processing for automatically generating order information for an online ordering system based on the purchase candidate information and providing an article to the user through a delivery service,
extract ancillary service information including food-related service or movement service based on the generation result and the preference information, the intake restriction information, and the emotion evaluation information, and present the ancillary service information as related proposal information to the user, and extract feature quantities from the generation result, the evaluation information, and the emotion evaluation information, update a learning model that performs machine learning processing, and thereby automatically adjust the prompt sentence and the cooking parameters to be generated in subsequent processing so as to evolve proposal contents.

### (Supplementary 2)

The system according to supplementary 1,
wherein the processor is configured to
perform a ranking process that determines a presentation order of merchandise information and service information related to the meal plan information and the cooking procedure information based on the evaluation information acquired from the participants and the emotion evaluation information, and reflect a result of the ranking process in the context information to be input to the generative AI model.

### (Supplementary 3)

The system according to supplementary 1,
wherein the processor is configured to
repeatedly and continuously present the meal plan information and the cooking procedure information to a plurality of participants via the group communication function of the information communication application, and provide additional proposal information including the ancillary service information together with the presentation, thereby maintaining daily contact in a household or a group and promoting conclusion of additional transactions related to the merchandise information and the service information.

What is claimed is:

1. A system comprising:
circuitry configured to:
receive, via a communication interface coupled to a packet-switched network, text information from terminal devices of a plurality of users participating in a group communication session, the text information including resource availability information input by the users, and store the resource availability information in an item-information storage region of a storage device;
convert, by natural language processing, preference information and constraint information of the participants acquired via the communication interface into structured attribute information, and store the structured attribute information in a preference-information storage region of the storage device;
generate a prompt sentence based on the resource availability information and the structured attribute information, input the prompt sentence to a generative AI model, and obtain a generation result including a resource utilization plan and associated procedure information from the generative AI model; and
evaluate an emotional state of a user based on data received from the terminal devices via the communication interface, optimize the generation result based on the evaluated emotional state, and transmit the optimized generation result to the terminal devices via the communication interface.

2. The system according to claim 1, wherein the circuitry is configured to extract item candidates from the text information, normalize the item candidates into identifier information representing generalized item categories, and store the identifier information in the item-information storage region.

3. The system according to claim 2, wherein the circuitry is configured to compare items required for the resource utilization plan with the identifier information stored in the item-information storage region, identify missing items, transmit order information for the missing items to an external transaction processing system via the communication interface, and cause the missing items to be provided to a user through a fulfillment service.

4. The system according to claim 3, wherein the circuitry is configured to collect feedback from the participating users regarding the resource utilization plan and associated procedure information, and incorporate the feedback into the prompt sentence supplied to the generative AI model for subsequent interactions to refine subsequent generation results.

5. The system according to claim 4, wherein the circuitry is configured to update the item-information storage region and the preference-information storage region in response to additional inputs from the users received via the communication interface, reconfigure the prompt sentence based on updated contents, and repeatedly obtain updated resource utilization plans from the generative AI model.

6. The system according to claim 1, wherein the circuitry is configured to format the generation result into a text format adapted to an interface specification of a message-processing application, and transmit the formatted text to a group communication screen of the message-processing application so that the generation result is shared among the participating users.

7. The system according to claim 1, wherein the circuitry is configured to receive, via the communication interface, image data from the terminal devices representing stored items, analyze the image data to extract item information, and update the resource availability information stored in the storage device based on the extracted item information.

8. The system according to claim 1, wherein the circuitry is configured to receive leftover food information representing contents of a storage apparatus input by the users in a group chat of a messenger application, and store the leftover food information as resource availability information in the item-information storage region.

9. The system according to claim 8, wherein the circuitry is configured to receive preference information and dietary restriction information of the participating users from the terminal devices via the communication interface, and store the preference information and the dietary restriction information as structured attribute information in the preference-information storage region.

10. The system according to claim 9, wherein the circuitry is configured to generate the prompt sentence for the generative AI model to propose a menu and cooking procedures based on the leftover food information and the preference information and dietary restriction information of the participating users.

11. The system according to claim 10, wherein the circuitry is configured to identify, based on the proposed menu, one or more missing ingredients not included in the leftover food information, automatically place an order for the missing ingredients via an online ordering system, and cause the missing ingredients to be provided to the users through a delivery service.

12. The system according to claim 11, wherein the circuitry is configured to promote communication among the participating users through the proposed menu and cooking procedures so as to generate additional interaction data for collection and analysis by the generative AI model.

13. The system according to claim 1, wherein the circuitry is configured to evaluate the emotional state of the user by applying an emotion analysis engine to at least one of text content, vocal characteristics, and behavioral patterns derived from data received from the terminal devices.

14. The system according to claim 13, wherein the circuitry is configured to modify at least one of a content selection criterion, a presentation style, and a constraint weighting in the resource utilization plan based on the evaluated emotional state of the user.

15. The system according to claim 1, wherein the circuitry is configured to store records of generation results and associated user feedback in the storage device, and use the stored records to generate personalized prompt sentences for individual users participating in the group communication session.

16. The system according to claim 1, wherein the circuitry is configured to receive user preference update data from the terminal devices via the communication interface after presentation of the generation result, update the structured attribute information in the preference-information storage region based on the received update data, and regenerate the prompt sentence for the generative AI model.

17. The system according to claim 16, wherein the circuitry is configured to track changes in the structured attribute information over time in the storage device, and use the tracked changes to adapt the prompt sentence to reflect evolving preferences of the participating users.

18. A system comprising:
circuitry configured to:
receive, via a communication interface coupled to a packet-switched network, text information from terminal devices of a plurality of users participating in a group communication session, extract item candidates from the text information, normalize the item candidates into identifier information, and store the identifier information in a storage device;
convert preference information and constraint information of the participants into structured attribute information, generate a prompt sentence based on the identifier information and the structured attribute information, and input the prompt sentence to a generative AI model to obtain a resource utilization plan and associated procedure information;
compare items required for the resource utilization plan with the identifier information, identify missing items, and transmit order information for the missing items to an external transaction processing system via the communication interface; and
evaluate an emotional state of a user based on data received from the terminal devices, optimize the resource utilization plan based on the evaluated emotional state, and transmit the optimized resource utilization plan to the terminal devices via the communication interface.

19. The system according to claim 18, wherein the circuitry is configured to collect feedback from the participating users regarding the resource utilization plan, incorporate the feedback into the prompt sentence for the generative AI model, and update the identifier information and the structured attribute information in the storage device based on additional inputs to iteratively refine subsequent resource utilization plans.

20. A method comprising:
receiving, via a communication interface coupled to a packet-switched network, text information from terminal devices of a plurality of users participating in a group communication session, the text information including resource availability information input by the users, and storing the resource availability information in a storage device;
converting, by natural language processing, preference information and constraint information of the participants into structured attribute information, and storing the structured attribute information in the storage device;
generating a prompt sentence based on the resource availability information and the structured attribute information, inputting the prompt sentence to a generative AI model, and obtaining a generation result including a resource utilization plan and associated procedure information from the generative AI model; and
evaluating an emotional state of a user based on data received from the terminal devices via the communication interface, optimizing the generation result based on the evaluated emotional state, and transmitting the optimized generation result to the terminal devices via the communication interface.
